(19) United States
(12) Patent Application Publication
(10) Pub. No.: US 2026/0198531 A1
(43) Pub. Date: Jul. 16, 2026

(54) EDIBLE BEADS COMPRISING A TEA EXTRACT

(71) Applicant: Koninklijke Douwe Egberts B.V., Utrecht (NL)

(72) Inventors: Gayle Harris, Utrecht (NL); Sarah Zargarpour, Utrecht (NL); Jos Sluys, Utrecht (NL); Angenita Dorothea Van Loon-Post, Utrecht (NL)

(21) Appl. No.: 19/128,975

(22) PCT Filed: Nov. 10, 2023
(86) PCT No.: PCT/EP2023/081535

§ 371 Date: May 9, 2025

(30) Foreign Application Priority Data
Nov. 11, 2022 (GB) 2216876.9

(51) Int. Cl. A23L 2/395; A23F 3/16; A23F 3/32; A23L 29/256; A23L 29/30; A23L 33/22; A23P 10/30

(52) U.S. Cl. CPC A23L 2/395; A23F 3/163; A23F 3/32; A23L 29/256; A23L 29/30; A23L 33/22; A23P 10/30

(57) ABSTRACT

The present invention relates to an edible bead comprising an outer polysaccharide gel membrane and a filling, wherein the filling comprises a tea extract and at least one soluble dietary fibre and wherein the filling comprises less than 15 wt. % sugars by weight of the filling. The present invention also relates to a process for preparing an edible bead, the process comprising the steps of: a) preparing a first solution comprising a metal salt, a tea extract and at least one soluble dietary fibre; b) preparing a second solution comprising at least one polysaccharide; and c) contacting the first solution with the second solution to form a polysaccharide gel membrane and encapsulating the first solution in the polysaccharide gel membrane.

### TECHNICAL FIELD OF THE INVENTION

The present invention relates to edible beads. In particular, the present invention relates to edible beads having a filling comprising a tea extract.

### BACKGROUND TO THE INVENTION

It is known to encapsulate one or more food ingredients in edible beads to provide a more interesting in mouth sensorial consumer experience.

Moreover, it is known to incorporate one or more edible beads in beverage products and food products. However, typically, existing beverage products or food products comprising one or more edible beads are high in sugar.

In recent years, there has been a significant attention to sugar and the higher associated energy density of products high in sugar. As such, there have been various attempts by food and drink manufacturers to reduce sugar in food and drinks. However, sugar provides the appealing sweetness that consumers expect. Moreover, in the case of edible beads in beverage and/or food products, the sugar increases the density of the liquid so that it better forms the bead during preparation.

Consequently, there exists a need to provide edible beads comprising a tea extract filling having a reduced amount of sugars and/or calories compared to a “full sugar” edible bead.

It is also an aim of the present invention to provide an edible bead comprising a tea extract filling.

It is also an aim of the present invention to provide a beverage and/or food product comprising one or more edible beads having a tea extract filling which tastes similar to a beverage and/or food product comprising one or more “full sugar” edible beads.

It is also an aim of the present invention to provide an edible bead and/or a food or beverage product comprising one or more edible beads that addresses at least one disadvantage of the prior art or to provide an alternative to existing edible beads and/or a food or beverage product comprising one or more edible beads.

It is therefore an aim of embodiments of the invention to overcome or mitigate at least one problem of the prior art, whether disclosed herein or not.

### SUMMARY OF THE INVENTION

According to a first aspect of the present invention there is provided an edible bead comprising an outer polysaccharide gel membrane and a filling, wherein the filling comprises a tea extract and at least one soluble dietary fibre and wherein the filling comprises less than 15 wt. % sugars by weight of the filling.

Surprisingly, the inventors found that incorporating at least one soluble dietary fibre ingredient into the edible bead was able to significantly reduce the amount of sugars and calories of the tea extract-containing edible bead whilst still providing an acceptable taste and similar ease of preparation as a “full sugar” tea extract-containing edible bead. Moreover, the beads are able to increase daily intake of dietary fibre and provide a tea flavouring.

In addition, the inventors found that the addition of a tea extract to the filling of an edible bead helped to reduce the pH of the filling. Beneficially, this was observed to improve the preservation of the ingredients in the edible bead.

By “edible bead” it is meant an edible composition comprising a filling encapsulated by an outer gel membrane.

By “sugars” it is meant monosaccharides and disaccharides. The sugars may be one or more sugars selected from the group consisting of glucose, sucrose, fructose, galactose, lactose, maltose, isomaltose and sugar hydrates (such as dextrose monohydrate, for example), among others.

By “soluble dietary fibre” it is meant a plant-based or plant-derived carbohydrate, animal-based or animal derived fibre that is not digested in the small intestine and is soluble in water. Soluble dietary fibres are differentiated from insoluble dietary fibres which are not soluble in water.

The tea extract may be caffeinated and/or decaffeinated.

The tea extract may be an extraction produced from the leaves of any part of a plant.

The plant may be selected from the group consisting of fruits, herbs, medicinal plants, tea, vegetables and spices, including mixtures thereof, such as, for example, mixtures of herbs, vegetables and/or spices.

The fruits, herbs, medicinal plants, tea, vegetables and spices may be selected from example selected from artemisia, balm, basil, chai, chamomile, chive, cloves, coffee, coriander, dill, garlic, ginger, ginseng, gingko, jasmine, lavender, matcha, mint, orange blossom, oregano, persil, rooibos, Rosa centifolia, rosemary, thyme, turmeric, sage, pepper, chili pepper, rose, Stevia rebaudiana, tarragon, white tea, yellow tea, green tea, oolong tea, black tea, pu-erh tea, vanilla, red or green vine, violet and/or willow.

The tea extract may also comprise added aromas, fruit parts and spices.

The tea extract may be black tea, white tea, fruit tea, green tea, rooibos tea, oolong tea, chamomile tea, peppermint tea, ginger tea, cinnamon tea, lemongrass tea, rosemary tea, pu-erh tea, olive leaf tea, barley tea, liquorice tea, eucalyptus tea, gingko tea, sage tea, raspberry tea, valerian root tea, elderberry flower tea, lavender tea, turmeric tea, purple tea, pine needle tea, echinacea tea, honeybush tea, rose tea, jasmine tea, cranberry tea, dandelion tea, guava tea, thyme tea, matcha tea, chai tea, lemon balm tea, and any mixture thereof.

The tea extract may be in the form of a liquid tea extract, infusion, an instant soluble tea extract, spray dried tea extract, freeze dried tea extract, and/or a blend of freeze dried soluble tea extract.

Preferably, the tea extract is in the form of a liquid tea extract.

The liquid tea extract may be a liquid tea extract concentrate.

The tea extract may be present in an amount of at least 1 wt. % or at least 2, 3, 4, 5, 6, or at least 7 wt. % by weight of the filling. In some embodiments, the tea extract may be present in an amount of no more than 20 wt. % by weight of the filling, or less than 19, 18, 17, 16, 15, 14, 13, 12, 11, or no more than 10 wt. % by weight of the filling.

In some embodiments, the tea extract may be present in an amount of 1-20 wt. % by weight of the filling, or 1-19, 1-18, 1-17, 1-16, 1-15, 2-15, 3-15, 4-15, 4-14, 4-13, 4-12, 5-12, 6-12, 7-12, or 9-11 wt. % by weight of the filling.

The filling may have a total dissolved tea solids amount of at least 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, 4.9%, 5%, 6%, 7%, 8%, 9%, or at least 10%.

The filling may have a total dissolved tea solids amount of no more than 20%, 19%, 18%, 17%, 16%, 15%, 14%, 13%, 12%, 11%, or no more than 10%.

Preferably, the filling may have a total dissolved tea solids amount of 1.0-20%, 1-15%, 5-15%, 6-15%, 7-15%, 8-15%, 6-14%, 7-13%, 8-12%, 9-12%, or 10-12%, 10.5-11.6%.

The total amount of caffeine in the filling may be at least 0.01 wt. %, 0.02 wt. %, 0.03 wt. %, 0.04 wt. %, 0.05 wt. % by weight of the filling. The total amount of caffeine in the filling may be no more than 0.15 wt. %, 0.14 wt. %, 0.13 wt. %, 0.12 wt. %, 0.11 wt. %, 0.10 wt. %, 0.09 wt. %, 0.08 wt. % by weight of the filling.

The total amount of caffeine in the filling may be from 0.01-0.15 wt. %, 0.02-0.14 wt. %, 0.03-0.13 wt. %, 0.04-0.12 wt. %, 0.04-0.11 wt. %, 0.04-0.10 wt. %, 0.04-0.09 wt. %, 0.05-0.09 wt. % or 0.06-0.08 wt. % by weight of the filling.

The filling may comprise less than 14 wt. %, 13 wt. %, 12 wt. %, 11 wt. %, 10 wt. %, 9 wt. %, 8 wt. %, 7 wt. %, 6 wt. %, 5 wt. %, 4 wt. %, 3 wt. %, 2 wt. %, 1 wt. %, 0.9 wt. %, 0.8 wt. %, 0.7 wt. %, 0.6 wt. %, 0.5 wt. %, 0.4 wt. %, 0.3 wt. %, 0.2 wt. % or less than 0.1 wt. % sugars.

In some embodiments the filling may be essentially free from or free from sugar.

In some embodiments, the filing may comprise less than 10, 5, 4, 3, 2, 1 or 0.5 wt. % sucrose, and comprise substantially no sucrose or no sucrose.

In some embodiments the filling composition may comprise less than 10, 5, 4, 3, 2, 1 or 0.5 wt. % glucose, and comprise substantially no glucose or no glucose.

The at least one soluble dietary fibre may comprise at least one dietary fibre selected from the group consisting of inulin, fructooligosaccharide (FOS), levan, polydextrose, kestose, nystose, raffinose, galacto-oligosaccharides, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, milk oligosaccharides, 2′-fucosyl lactose, lacto-n-neotetraose, glucan (i.e., glucose containing) oligosaccharides, cello-oligosaccharides (or cellodextrins), resistant dextrins (e.g., soluble corn fiber, soluble wheat fiber, soluble tapioca fiber, soluble pea fibre), nigero-oligosaccharides, nigerotriose, nigerotetraose, kojitriose, kojitetraose, dextrans, beta glucans, lichenan, isolichenan, and combinations thereof. In some embodiments the further soluble dietary fibre may comprises tapioca fibre and/or pea fibre.

Preferably, the at least one soluble dietary fibre is inulin, galacto-oligosaccharide, polydextrose and/or fructooligosaccharide.

The at least one soluble dietary fibre may be a short chain fibre and/or medium chain fibre.

The short chain fibre may have a degree of polymerisation of no more than 10, 9, 8, 7, 6, 5, 4, 3 or no more than 2.

In some embodiments, short chain fibre may have a degree of polymerisation of from 2-10, 2-9, or from 2-8.

The medium chain fibre may have a degree of polymerisation of no more than 60, 50, 40, 30, 20, or no more than 15.

In some embodiments, the medium chain fibre may have a degree of polymerisation of from 8-60, 8-50, 8-40, 8-30, 8-20, 10-60, 15-60, 20-60, 20-50, or from 20-40.

Preferably, the at least one soluble fibre is a short and/or medium chain inulin.

The short chain inulin may have a degree of polymerisation of no more than 10, 9, 8, 7, 6, 5, 4, 3 or no more than 2.

In some embodiments, short chain inulin may have a degree of polymerisation of from 2-10, 2-9, or from 2-8.

The medium chain inulin may have a degree of polymerisation of no more than 60, 50, 40, 30, 20, or no more than 15.

In some embodiments, the medium chain inulin may have a degree of polymerisation of from 8-60, 8-50, 8-40, 8-30, 8-20, 10-60, 15-60, 20-60, 20-50, or from 20-40.

The at least one soluble dietary fibre may be present in an amount of at least 5 wt. % by weight of the filling, or at least 6, 7, 8, 9, 10, 11, 12, 13, 14, 15, 16, 17, 18, 19, or at least 20 wt. % by weight of the filling. In some embodiments, the at least one soluble dietary fibre may be present in an amount of no more than 40 wt. % by weight of the filling or no more than 39, 38, 37, 36, 35, 34, 33, 32, 31, 30, 29, 28, 27, 26, 25, 24, 23, 22, 21, or no more than 20 wt. % by weight of the filling.

In some embodiments, the at least one soluble dietary fibre may be present in an amount of 5-40 wt. % soluble dietary fibre, or 6-35, 7-35, 8-35, 9-35, 10-35, 11-35, 12-35, 13-35, 14-35, 15-35, 16-35, 17-35, 18-35, 19-35, or 20-30 wt. % by weight of the filling.

The filling may comprise one, two, three, four, five, six, seven, eight, nine or ten soluble dietary fibres.

In some embodiments, the filling may comprise a plurality of soluble dietary fibres.

The polysaccharide of the membrane may be a hydrocolloid.

The polysaccharide membrane may comprise a polysaccharide selected from the group consisting of alginate, low methoxy pectin, guar gum and combinations thereof

Preferably, the polysaccharide is alginate. More preferably, the alginate is an alkaline earth metal alginate

The alginate may be calcium alginate.

The filling of the edible beads is preferably a liquid.

This improves consumer experience by providing a ‘burst’ sensation. Moreover, a liquid filling provides an optimum medium to dissolve the ingredients of the filling.

Preferably, the filling does not comprise a hydrocolloid.

In some embodiments, the filling does not comprise a polysaccharide selected from the group consisting of alginate, low methoxy pectin, guar gum and combinations thereof.

Beneficially, the inventors found that by providing an edible bead wherein the filling does not comprise a hydrocolloid, the filling of the bead does not solidify and/or gel over time. This allows the bead to be stored for longer periods of time and ensures that all beads provide the same desirable liquid filling and “bursting” sensation.

The filling may comprise coffee.

The coffee may be caffeinated and/or decaffeinated.

The coffee may be a liquid coffee, an instant soluble coffee, spray dried coffee, freeze dried coffee, a blend of freeze dried soluble coffee, roast and ground coffee, and/or microground roast and ground coffee.

Preferably, the coffee is a liquid coffee.

The liquid coffee may be a liquid coffee concentrate.

The liquid coffee may be derived from roast and ground coffee.

In some embodiments, the roast and ground coffee may be derived from pure Arabica whole coffee beans.

In some embodiments, the roast and ground coffee may be derived from pure Robusta whole coffee beans.

In other embodiments, the roast and ground coffee may be derived from a mixture of Arabica and Robusta whole coffee beans.

The coffee may be present in an amount of at least 1 wt. % or at least 2, 3, 4, 5, 6, or at least 7 wt. % by weight of the filling. In some embodiments, the coffee may be present in an amount of no more than 20 wt. % by weight of the filling, or less than 19, 18, 17, 16, 15, 14, 13, 12, 11, 10, 9, or no more than 8 wt. % by weight of the filling.

In some embodiments, the coffee may be present in an amount of 1-20 wt. % by weight of the filling, or 1-19, 1-18, 1-17, 1-16, 1-15, 2-15, 3-15, 4-15, 4-14, 4-13, 4-12, 5-11, 5-10, 6-9, or 6-8 wt. % by weight of the filling.

The filling may have total dissolved coffee solids amount of at least 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, 4.9%, 5%.

The filling may have total dissolved coffee solids amount of no more than 6%, 5.9%, 5.8%, 5.7%, 5.6%, 5.5%, 5.4%, 5.3%, 5.2%, 5.1%, 5.0%, 4.9%, 4.8%, 4.7%, 4.6%, 4.5%, 4.4%, 4.3%, 4.2%, 4.1%, 4.0%, 3.9%, 3.8%, 3.7%, 3.6%, 3.5%, 3.4%, 3.3%, 3.2%, 3.1% or no more than 3.0% or 5.1%, 5.2%, 5.3%, 5.4%, 5.5%, 5.6%, 5.7%, 5.8%, 5.9% or at least 6%.

Preferably, the filling may have total dissolved coffee solids amount of 1.0-7.0%, 1-7.0%, 1.5-7.0%, 1.5-6.0%, 1.5-5.5%, 1.5-5.0%, 1.5-5.0%, 1.5-4.5%, 1.5-4.0%, 1.5-3.5%, or 1.5-3.0%, 1.5-2.5%.

The filling may comprise a non-dairy creamer.

In such an embodiment, the filling may comprise a fat in an amount of at least 6, 7, 8, 9, 10, 11, 12, 13, 14, 15, 16, 17, 18, 19, or at least 20 wt. % by weight of the filling. In some embodiments, the fat may be present in an amount of no more than 40 wt. % by weight of the filling or no more than 39, 38, 37, 36, 35, 34, 33, 32, 31, 30, 29, 28, 27, 26, 25, 24, 23, 22, 21, or no more than 20 wt. % by weight of the filling.

In some embodiments, the fat may be present in an amount of 5-40 wt. % by weight of the filling, or 6-35, 7-35, 8-35, 9-35, 10-35, 11-35, 12-35, 13-35, 14-35, 15-35, 16-35, 17-35, 18-35, 19-35, or 20-30 wt. % by weight of the filling.

“Non-dairy creamer” refers to a product that replicates the mouthfeel and/or flavour of dairy milk and comprises a fat.

The non-dairy creamer may contain from about 0.1-95, 10-95, 15-95, 20-95, 25-95, 30-95, 35-95, 40-95, 45-95, 50-95, 55-95, 60-95, 65-95, 70-95, 75-95, 80-95, 85-95, 80-90, 85-90 wt. % of fats by weight of the non-dairy creamer.

The fat may be a vegetable fat.

The vegetable fat may be derived from a coconut, cocoa bean, palm fruit, sunflower seeds, soybean seeds, palm kernel, cotton seeds, canola seeds, olives, safflower seeds, or any combination thereof.

Preferably, the vegetable fat is derived from a coconut.

The vegetable fat may be a vegetable oil and/or a vegetable butter.

The vegetable oil may be a partially or wholly hydrogenated oil.

The vegetable oil may be a refined oil.

The vegetable oil and/or vegetable butter may comprise 50-100 wt. %, more preferably 70-100 wt. % and most preferably 90-100 wt. % of triglycerides.

The triglycerides of the vegetable oil and/or vegetable butter may have a lauric acid content of from about 5-60, 25-60, 40-60, or 40-50 wt. %, by weight of the total fatty acid content.

The triglycerides of the vegetable oil and/or vegetable butter may have a palmitic acid content of from about 1-45, 1-40, 1-30, 1-20, 1-15, or 1-10 wt. % by weight of the total fatty acid content.

The triglycerides of the vegetable oil and/or vegetable butter may have a myristic acid content of from about 2-30, 5-30, 5-25, 5-20, or 10-20 wt. % by weight of the total fatty acid content.

The triglycerides of the vegetable oil and/or vegetable butter may have a stearic acid content of from about 0.1-40, 0.1-35, or 1-3 wt. % by weight of the total fatty acid content.

The triglycerides of the vegetable oil and/or vegetable butter may have a linoleic acid content of from about 0.1-10, 0.5-5, or 1-3 wt. % by weight of the total fatty acid content.

The triglycerides of the vegetable oil and/or vegetable butter may have a caprylic acid content of from 1-30, 1-25, 1-20, 1-15, 1-10, 2-10, 3-10, 4-10, or 5-10 wt. % by weight of the total fatty acid content.

The triglycerides of the vegetable oil and/or vegetable butter may have a capric acid content of from 1-30, 1-25, 1-20, 1-15, 1-10, 2-10, 3-10, 4-10, or 5-10 wt. % by weight of the total fatty acid content.

The triglycerides of the vegetable oil and/or vegetable butter may have an oleic acid content of from 1-40, 1-25, 1-20, 1-15, 1-10, 1-8, or 2-8 wt. %, by weight of the total fatty acid content.

The triglycerides of the vegetable oil and/or vegetable butter may have a lauric acid content of from about 5-60 wt. % by weight of the total fatty acid content; a palmitic acid content of from about 1-45 wt. % by weight of the total fatty acid content; and a myristic acid content of from about 2-30 wt. % by weight of the total fatty acid content.

The triglycerides of the vegetable oil and/or vegetable butter may have a lauric acid content of from 40-50 wt. % by weight of the total fatty acid content; a palmitic acid content of from 1-10 wt. % by weight of the total fatty acid content; and a myristic acid content of from 10-20 wt. % by weight of the total fatty acid content.

The triglycerides of the vegetable oil and/or vegetable butter may have a stearic acid content of from about 0.1-40 wt. %, by weight of the total fatty acid content; a palmitic acid content of from about 1-45 wt. % by weight of the total fatty acid content; and an oleic acid content of from about 2-40 wt. % by weight of the total fatty acid content.

The triglycerides of the vegetable oil and/or vegetable butter may have a stearic acid content of from about 30-40 wt. % by weight of the total fatty acid content; a palmitic acid content of from about 20-30 wt. % by weight of the total fatty acid content; and an oleic acid content of from about 30-40 wt. % by weight of the total fatty acid content.

In some embodiments, the triglycerides of the vegetable oil and/or vegetable butter may have a lauric acid content of from about 5-60 wt. % by weight of the total fatty acid content; a palmitic acid content of from about 1-45 wt. % by weight of the total fatty acid content; a myristic acid content of from about 2-30 wt. % by weight of the total fatty acid content; a stearic acid content of from about 0.1-5 wt. % by weight of the total fatty acid content; a linoleic acid content of from about 0.1-10 wt. % by weight of the total fatty acid content; a caprylic acid content of from 1-30 wt. %, by weight of the total fatty acid content; a capric acid content of from 1-30 wt. % by weight of the total fatty acid content; and an oleic acid content of from 1-30 wt. % by weight of the total fatty acid content.

Preferably, the triglycerides of the vegetable oil and/or vegetable butter have a lauric acid content of from 40-50 wt. % by weight of the total fatty acid content; a palmitic acid content of from 1-10 wt. % by weight of the total fatty acid content; a myristic acid content of from 10-20 wt. % by weight of the total fatty acid content; a stearic acid content of from 1-3 wt. % by weight of the total fatty acid content; a linoleic acid content of from 1-3 wt. % by weight of the total fatty acid content; a caprylic acid content of from 5-10 wt. % by weight of the total fatty acid content; capric acid content of from 5-10 wt. % by weight of the total fatty acid content; and an oleic acid content of from 2-8 wt. % by weight of the total fatty acid content.

The vegetable butter may be soybean butter, coconut butter, palm butter, canola butter, sunflower butter, and other butters, or a combination thereof.

The vegetable oil may be soybean oil, coconut oil, palm oil, palm kernel oil, cotton seed oil, canola oil, olive oil, sunflower oil, safflower oil and other oils, or a combination thereof.

Preferably, the vegetable oil is a coconut oil. More preferably, the vegetable oil is a refined coconut oil.

The non-dairy creamer may also include an emulsifier.

In such an embodiment, the emulsifier may be present in an amount of no more than 10 wt. % by weight of the filling or no more than 9, 8, 7, 6, 5, 4, 3, 2, 1, 0.9, 0.8, 0.7, 0.6, 0.5, 0.4, 0.3, 0.2, or no more than 0.1 wt. % by weight of the filling.

In some embodiments, the emulsifier may be present in an amount of 0.1-10 wt. % by weight of the filling, or 0.2-10, 0.3-10, 0.4-9, 0.5-8 0.6-7, 0.7-6, 0.8-5, 0.9-4, 1-3, or 1-2 wt. % by weight of the filling.

The emulsifier may be a monoglyceride, diglyceride, lecithin, diacetyl tartaric acid esters of mono-diglycerides (DATEM), stearoyl lactylates, modified food starches, polysorbates, polysorbate 20, polysorbate 60, polysorbate 80, PGA, and mixtures thereof.

The non-dairy creamer may contain from about 0.1-10, 0.2-10, 0.3-10, 0.4-10, 0.5-10, 0.5-8, 0.5-5, 0.6-5, 0.7-5, 0.8-5, 0.9-5, 1-5, 1.5-4, 1.5-3.5, 2-3.5, 2-3 wt. % of an emulsifier by weight of the non-dairy creamer.

The non-dairy creamer may be a liquid, powder, gel, and/or emulsion.

Preferably, the non-dairy creamer is an emulsion.

The filling may comprise one or more further ingredients. The further ingredients may be a flavouring, sweetener, organic acids, nutraceutical, colouring agent and/or thickening agent.

The thickening agent may include starch, modified starch, xanthan, galactomannans, such as guar gum and locust bean gum (LBG), gum Arabic, gum karaya, gum tragacanth and carboxymethyl cellulose (CMC).

The thickening agent may be present in an amount of no more than 10 wt. % by weight of the filling or no more than 9, 8, 7, 6, 5, 4, 3, 2, 1, 0.9, 0.8, 0.7, 0.6, 0.5, 0.4, 0.3, 0.2, or no more than 0.1 wt. % by weight of the filling.

In some embodiments, the thickening agent may be present in an amount of 0.01-5 wt. % by weight of the filling, or 0.01-4, 0.02-3, 0.03-2, 0.04-2, 0.05-2, 0.05-1, 0.05-0.5, 0.05-0.4, 0.05-0.3, 0.05-0.3, 0.06-1.4, 0.07-0.3, 0.08-0.2, or 0.09-0.1 wt. % by weight of the filling.

The flavouring may include chocolate powder (or cocoa) or a flavouring selected from chocolate (or cocoa), vanilla, strawberry, cinnamon, mint, hazelnut, caramel, biscuit, gingerbread, fruit flavouring, vegetable flavouring, spices, pumpkin spice, pistachio, eggnog, Irish Cream, alcoholic beverage flavouring, liqueurs, beer, rum, wine, gin cognac, plant and herb flavourings, agrimony, alfalfa, aloe vera, amaranth, angelica, anise, barberry, basil, bayberry, bee pollen, birch, bistort, blackberry, black cohosh, black walnut, blessed thistle, blue cohosh, blue vervain, boneset, borage, buchu, buckthorn, bugleweed, burdock, capsicum, cayenne, caraway, catnip, celery, centaury, chamomile, chaparral, chickweed, chinchona, cloves, coltsfoot, comfrey, cornsilk, couch grass, cramp bark, culver's root, cyani, cornflower, damiana, dandelion, devils claw, dong quai, echinacea, elecampane, ephedra, eucalyptus, evening primrose, eyebright, false unicorn, fennel, fenugreek, figwort, flaxseed, guarana, garlic, gentian, ginger, ginkgo, ginseng, golden seal, gotu kola, gum weed, hawthorn, hops, horehound, horseradish, horsetail, hoshouwu, hydrangea, hyssop, iceland moss, irish moss, jojoba, juniper, kelp, lady's slipper, lemon grass, licorice, lobelia, mandrake, marigold, marjoram, marshmallow, mistletoe, mullein, mustard, myrrh, nettle, oatstraw, Oregon grape, papaya, parsley, passion flower, peach, pennyroyal, peppermint, periwinkle, plantain, pleurisy root, pokeweed, prickly ash, psyllium, quassia, queen of the meadow, red clover, red raspberry, redmond clay, rhubarb, rose hips, rosemary, rue, safflower, saffron, sage, St. John's wort, sarsaparilla, sassafras, saw palmetto, scullcap, senega, senna, shepherd's purse, slippery elm, spearmint, spikenard, squawvine, stillingia, strawberry, taheebo, uva ursi, valerian, violet, watercress, white oak bark, white pine bark, wild cherry, wild lettuce, wild yam, willow, wintergreen, witch hazel, wood betony, wormwood, yarrow, yellow dock, yerba santa, yucca, lavender, thyme, or a combination of two or more thereof.

The flavouring may be present in an amount of no more than 10 wt. % by weight of the filling or no more than 9, 8, 7, 6, 5, 4, 3, 2, 1, 0.9, 0.8, 0.7, 0.6, 0.5, 0.4, 0.3, 0.2, or no more than 0.1 wt. % by weight of the filling.

In some embodiments, the flavouring may be present in an amount of 0.01-5 wt. % by weight of the filling, or 0.01-4, 0.02-3, 0.03-1, 0.04-1, 0.05-1, 0.05-0.9, 0.05-0.8, 0.05-0.7, 0.05-0.6, 0.05-0.5, 0.06-0.4, 0.07-0.3, 0.08-0.2, or 0.09-0.2 wt. % by weight of the filling.

The sweetener may be selected from a carbohydrate-based sweetener or a non-carbohydrate based sweetener. The carbohydrate-based sweetener may be a sugar substitutes like e.g. polyols such as sorbitol, mannitol, xylitol or combinations thereof, maltodextrins, dried glucose syrups, malt extracts, starches, trehalose, raftiline, raftilose, galactose, honey powders, and mixtures of same. The non-carbohydrate based sweetener may be an artificial sweetener like e.g. Splenda®, Acesulfame K®, or aspartame, and mixtures of the same. The non-carbohydrate based sweetener may be a natural sweetener, such as stevia.

The sweetener may be present in an amount of no more than 10 wt. % by weight of the filling or no more than 9, 8, 7, 6, 5, 4, 3, 2, 1, 0.9, 0.8, 0.7, 0.6, 0.5, 0.4, 0.3, 0.2, or no more than 0.1 wt. % by weight of the filling.

In some embodiments, the sweetener may be present in an amount of 0.1-10 wt. % by weight of the filling, or 0.2-10, 0.3-10, 0.4-9, 0.5-8 0.6-7, 0.7-6, 0.8-5, 0.9-4, 1-3, or 1-2 wt. % by weight of the filling.

The organic acid may be citric acid, lactic acid, acetic acid, tannic acid, malic acid, and/or tartaric acid.

The organic acid may be present in an amount of no more than 10 wt. % by weight of the filling or no more than 9, 8, 7, 6, 5, 4, 3, 2, 1, 0.9, 0.8, 0.7, 0.6, 0.5, 0.4, 0.3, 0.2, or no more than 0.1 wt. % by weight of the filling.

In some embodiments, the organic acid may be present in an amount of 0.01-5 wt. % by weight of the filling, or 0.01-4, 0.02-3, 0.03-2, 0.04-2, 0.05-2, 0.05-1, 0.05-0.5, 0.05-0.4, 0.05-0.3, 0.05-0.3, 0.06-1.4, 0.07-0.3, 0.08-0.2, or 0.1-0.2 wt. % by weight of the filling.

The nutraceutical may be selected from the group consisting of ascorbic acid (vitamin C), B vitamins, biotin, fat soluble vitamins, folic acid, HCA (hydroxycitric acid), inositol, pyruvate, mineral ascorbates, mixed tocopherols, niacin (vitamin B3), orotic acid, PABA (para-aminobenzoic acid), pantothenates, pantothenic acid (vitamin B5), pyridoxine hydrochloride (vitamin B6), riboflavin (vitamin B2), synthetic vitamins, thiamine (vitamin B1), tocotrienols, vitamin A, vitamin D, vitamin E, vitamin F, vitamin K, vitamin oils, vitamin premixes, vitamin-mineral premixes, water soluble vitamins, chromium, cobalt, copper, fluorine, iodine, magnesium, manganese, molybdenum, iron, nickel, phosphorous, potassium, selenium, silicon, sodium, strontium, sulfur, vanadium, zinc, and combinations thereof.

The nutraceutical may be present in an amount of no more than 10 wt. % by weight of the filling or no more than 9, 8, 7, 6, 5, 4, 3, 2, 1, 0.9, 0.8, 0.7, 0.6, 0.5, 0.4, 0.3, 0.2, or no more than 0.1 wt. % by weight of the filling.

In some embodiments, the nutraceutical may be present in an amount of 0.01-5 wt. % by weight of the filling, or 0.01-4, 0.02-3, 0.03-1, 0.04-1, 0.05-1, 0.05-0.9, 0.05-0.8, 0.05-0.7, 0.05-0.6, 0.05-0.5, 0.06-0.4, 0.07-0.3, 0.08-0.2, or 0.09-0.2 wt. % by weight of the filling.

The colouring agent may be selected from the group consisting of edible glitter and/or any edible food colouring.

The use of a colouring agent may improve the appearance of the bead.

The colouring agent may be present in an amount of no more than 10 wt. % by weight of the filling or no more than 9, 8, 7, 6, 5, 4, 3, 2, 1, 0.9, 0.8, 0.7, 0.6, 0.5, 0.4, 0.3, 0.2, or no more than 0.1 wt. % by weight of the filling.

In some embodiments, the colouring agent may be present in an amount of 0.01-5 wt. % by weight of the filling, or 0.01-4, 0.02-3, 0.03-1, 0.04-1, 0.05-1, 0.05-0.9, 0.05-0.8, 0.05-0.7, 0.05-0.6, 0.05-0.5, 0.06-0.4, 0.07-0.3, 0.08-0.2, or 0.09-0.2 wt. % by weight of the filling.

The filling may comprise water in an amount of at least 5 wt. % by weight of the filling, or at least 10, 15, 20, 25, 30, 35, 40, 45, or at least 50 wt. % by weight of the filling. In some embodiments, the filling may comprise water in an amount of no more than 80 wt. % by weight of the filling or no more than 75, 70, 65, 60, 55, or no more than 50 wt. % by weight of the filling.

In some embodiments, the filling may comprise water in an amount of 30-80 wt. % by weight of the filling, or 35-75, 40-65, 45-65, or 45-60 wt. % by weight of the filling.

The edible bead may have a diameter of at least 0.5 mm, 0.75 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, or at least 25 mm.

The edible bead may have a diameter of no more than 30 mm, 29 mm, 28 mm, 27 mm, 26 mm, 25 mm, 24 mm, 23 mm, 22 mm, 21 mm, 20 mm, 19 mm 18 mm, 17 mm, 16 mm, 15 mm, 14 mm, 13 mm, 12 mm, 11 mm, 10 mm, 9 mm, 8 mm, 7 mm, 6 mm, or no more than 5 mm.

The edible bead may have a diameter of from 0.5-30 mm, 0.5-25 mm, 0.5-20 mm, 0.5-15 mm, 0.5-10 mm, 0.5-5 mm, 1-30 mm, 5-30 mm, 10-30 mm, 15-30 mm, 20-30 mm, 25-30 mm, 1-30 mm, 5-25 mm, 5-15 mm 5-10 mm or from 10-20 mm.

The edible bead may have a weight of at least 0.03 g, 0.05 g, 0.1 g, 0.2 g, 0.3 g, 0.4 g, 0.5 g, 0.6 g, 0.7 g, 0.8 g, 0.9 g, 1.0 g, 1.1 g, 1.2 g, 1.3 g, 1.4 g, 1.5 g, 1.6 g, 1.7 g, 1.8 g, 1.9 g, 2.0 g, 2.1 g, 2.2 g or at least 2.3 g.

The edible bead may have a weight of no more than 2.6 g, 2.5 g, 2.4 g, 2.3 g, 2.2 g, 2.1 g, 2.0 g, 1.9 g, 1.8 g, 1.7 g, 1.6 g, 1.5 g, 1.4 g, 1.3 g, 1.2 g, 1.1 g, 1.0 g, 0.9 g, 0.8 g, 0.7 g, 0.6 g, 0.5 g, 0.4 g, 0.3 g, 0.2 g, or no more than 0.1 g.

The edible bead may have a weight of from 0.03-2.6 g, 0.05-2.6, 0.1-2.6 g, 0.2-2.6 g, 0.3-2.6 g, 0.4-2.6 g, 0.5-2.6 g, 0.6-2.6 g, 0.7-2.6 g, 0.8-2.6 g, 0.9-2.6 g, 1.0-2.6 g, 0.03-2.5 g, 0.03-2.4 g, 0.03-2.3 g, 0.03-2.2 g, 0.03-2.1 g, 0.03-2.0 g, 0.05-2.6 g, 0.1-2.5 g, 0.2, 2.4 g, 0.3-2.3 g, 0.4-2.2 g, 0.5-2.1 g, 0.6-2.0 g, 0.7-1.9 g, 0.8-1.8 g, 0.9-1.7 g, 1.0-1.6 g, 1.1-1.5 g, 0.5-2.0, 0.5-1.5, 0.5-1.0, 0.5-0.9, 0.5-0.8, 0.6-0.9, or from 0.6-0.8 g.

The membrane of the edible bead may have a thickness of at least 0.1 mm, 0.2, 0.3, 0.4, 0.5, 0.6, 0.7, 0.8, 0.9, 1, 1.5, 2.0, 3.0, 3.5, 4.0, 4.5, 5.0, 6.5, 7.0, 7.5, 8.0, 8.5, 9.0, 9.5, 10.0, 10.5, 11.0, 11.5, 12.0, 12.5, 13.0 13.5, 14.0, 14.5 or at least 15 mm.

The membrane of the edible bead may have a thickness of no more than no more than 20 mm, 15 mm, 10 mm, 9 mm, 6 mm, 5 mm, 4 mm, 3 mm, 2 mm, 1 mm, 0.9 mm 0.8 mm, 0.7 mm, 0.6 mm, 0.5 mm, 0.4 mm, 0.3 mm, 0.2 mm, or no more than 0.1 mm.

The edible bead may have a thickness of from 0.1-20 mm, 0.5-15 mm, 0.5-10 mm, 0.5-5 mm, 0.5-20 mm, 1-15 mm, 1-10 mm, 1-9 mm, 1-8 mm, 1-7 mm, 1-6 mm, or from 1-5 mm.

In a second aspect of the present invention, there is provided a process for preparing an edible bead, the process comprising the steps of:
a) preparing a first solution comprising a metal salt, a tea extract and at least one soluble dietary fibre;
b) preparing a second solution comprising at least one polysaccharide; and
c) contacting the first solution with the second solution to form a polysaccharide gel membrane and encapsulating the first solution in the polysaccharide gel membrane.

The Inventors found that the claimed process of the second aspect of the present invention ensured that the resulting encapsulated product remained liquid for a longer period of time. This is because the gel membrane forms externally to the first solution as the second solution is not able to penetrate the first solution. In contrast, in processes of the prior art in which the first solution comprises a polysaccharide, the gel membrane may form internally as well as externally of the first solution. Beneficially, this ensure that the product still has a liquid filling and subsequent ‘bursting’ sensation even after long periods of storage.

Moreover, the use of the above process can allow a broader range of filling ingredients and can result in the formation of a thicker membrane. Beneficially, this allows the resulting beads to be manipulated easily and allows them to conserve their shape better.

The metal salt may be an alkaline earth metal salt.

The metal salt may be a calcium salt.

In some embodiments, the calcium salt may be selected from the group consisting of calcium lactate, calcium chloride, calcium lactate gluconate and combinations thereof.

The metal salt may be present in an amount of no more than 10 wt. % by weight of the first solution or no more than 9, 8, 7, 6, 5, 4, 3, 2, 1, 0.9, 0.8, 0.7, 0.6, 0.5, 0.4, 0.3, 0.2, or no more than 0.1 wt. % by weight of the first solution.

In some embodiments, the metal salt may be present in an amount of 0.1-10 wt. % by weight of the first solution, or 0.2-10, 0.3-10, 0.4-9, 0.5-8 0.6-7, 0.7-6, 0.8-5, 0.9-4, 1-3, or 1-2 wt. % by weight of the first solution.

The at least one soluble dietary fibre may comprise at least one dietary fibre selected from the group consisting of inulin, fructooligosaccharide (FOS), levan, polydextrose, kestose, nystose, raffinose, galacto-oligosaccharides, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, milk oligosaccharides, 2′-fucosyl lactose, lacto-n-neotetraose, glucan (i.e., glucose containing) oligosaccharides, cello-oligosaccharides (or cellodextrins), resistant dextrins (e.g., soluble corn fiber, soluble wheat fiber, soluble tapioca fiber, soluble pea fibre), nigero-oligosaccharides, nigerotriose, nigerotetraose, kojitriose, kojitetraose, dextrans, beta glucans, lichenan, isolichenan, and combinations thereof. In some embodiments the further soluble dietary fibre may comprises tapioca fibre and/or pea fibre.

Preferably, the at least one soluble dietary fibre is inulin, galacto-oligosaccharide, polydextrose and/or fructooligosaccharide.

The at least one soluble dietary fibre may be present in an amount of at least 5 wt. % by weight of the first solution, or at least 6, 7, 8, 9, 10, 11, 12, 13, 14, 15, 16, 17, 18, 19, or at least 20 wt. % by weight of the first solution. In some embodiments, the at least one soluble dietary fibre may be present in an amount of no more than 40 wt. % by weight of the first solution or no more than 39, 38, 37, 36, 35, 34, 33, 32, 31, 30, 29, 28, 27, 26, 25, 24, 23, 22, 21, or no more than 20 wt. % by weight of the first solution.

In some embodiments, the at least one soluble dietary fibre may be present in an amount of 5-40 wt. % by weight of the first solution, or 6-35, 7-35, 8-35, 9-35, 10-35, 11-35, 12-35, 13-35, 14-35, 15-35, 16-35, 17-35, 18-35, 19-35, or 20-30 wt. % by weight of the first solution.

The first solution may comprise one, two, three, four, five, six, seven, eight, nine or ten soluble dietary fibres.

In some embodiments, the first solution may comprise a plurality of soluble dietary fibres.

The at least one soluble dietary fibre may be a short chain fibre and/or medium chain fibre.

The short chain fibre may have a degree of polymerisation of no more than 10, 9, 8, 7, 6, 5, 4, 3 or no more than 2.

In some embodiments, short chain fibre may have a degree of polymerisation of from 2-10, 2-9, or from 2-8.

The medium chain fibre may have a degree of polymerisation of no more than 60, 50, 40, 30, 20, or no more than 15.

In some embodiments, the medium chain fibre may have a degree of polymerisation of from 8-60, 8-50, 8-40, 8-30, 8-20, 10-60, 15-60, 20-60, 20-50, or from 20-40.

Preferably, the at least one soluble fibre is a short and/or medium chain inulin.

The short chain inulin may have a degree of polymerisation of no more than 10, 9, 8, 7, 6, 5, 4, 3 or no more than 2.

In some embodiments, short chain inulin may have a degree of polymerisation of from 2-10, 2-9, or from 2-8.

The medium chain inulin may have a degree of polymerisation of no more than 60, 50, 40, 30, 20, or no more than 15.

In some embodiments, the medium chain inulin may have a degree of polymerisation of from 8-60, 8-50, 8-40, 8-30, 8-20, 10-60, 15-60, 20-60, 20-50, or from 20-40.

The tea extract may be caffeinated and/or decaffeinated.

The tea extract may be an extraction produced from the leaves of any part of a plant.

The plant may be selected from the group consisting of fruits, herbs, medicinal plants, tea, vegetables and spices, including mixtures thereof, such as, for example, mixtures of herbs, vegetables and/or spices.

The fruits, herbs, medicinal plants, tea, vegetables and spices may be selected from example selected from artemisia, balm, basil, chai, chamomile, chive, cloves, coffee, coriander, dill, garlic, ginger, ginseng, gingko, jasmine, lavender, matcha, mint, orange blossom, oregano, persil, rooibos, Rosa centifolia, rosemary, thyme, turmeric, sage, pepper, chili pepper, rose, Stevia rebaudiana, tarragon, white tea, yellow tea, green tea, oolong tea, black tea, pu-erh tea, vanilla, red or green vine, violet and/or willow.

The tea extract may also comprise added aromas, fruit parts and spices.

The tea extract may be black tea, white tea, fruit tea, green tea, rooibos tea, oolong tea, chamomile tea, peppermint tea, ginger tea, cinnamon tea, lemongrass tea, rosemary tea, pu-erh tea, olive leaf tea, barley tea, liquorice tea, eucalyptus tea, gingko tea, sage tea, raspberry tea, valerian root tea, elderberry flower tea, lavender tea, turmeric tea, purple tea, pine needle tea, echinacea tea, honeybush tea, rose tea, jasmine tea, cranberry tea, dandelion tea, guava tea, thyme tea, matcha tea, chai tea, lemon balm tea, and any mixture thereof.

The tea extract may be in the form of a liquid tea extract, infusion, an instant soluble tea extract, spray dried tea extract, freeze dried tea extract, and/or a blend of freeze dried soluble tea extract.

Preferably, the tea extract is in the form of a liquid tea extract.

The liquid tea extract may be a liquid tea extract concentrate.

The tea extract may be present in an amount of at least 1 wt. % or at least 2, 3, 4, 5, 6, or at least 7 wt. % by weight of the first solution. In some embodiments, the tea extract may be present in an amount of no more than 20 wt. % by weight of the first solution, or less than 19, 18, 17, 16, 15, 14, 13, 12, 11, or no more than 10 wt. % by weight of the first solution.

In some embodiments, the tea extract may be present in an amount of 1-20 wt. % by weight of the first solution, or 1-19, 1-18, 1-17, 1-16, 1-15, 2-15, 3-15, 4-15, 4-14, 4-13, 4-12, 5-12, 6-12, 7-12, or 9-11 wt. % by weight of the first solution.

The first solution may have a total dissolved tea solids amount of at least 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, 4.9%, 5%, 6%, 7%, 8%, 9%, or at least 10%.

The first solution may have a total dissolved tea solids amount of no more than 20%, 19%, 18%, 17%, 16%, 15%, 14%, 13%, 12%, 11%, or no more than 10%.

Preferably, the first solution may have a total dissolved tea solids amount of 1.0-20%, 1-15%, 5-15%, 6-15%, 7-15%, 8-15%, 6-14%, 7-13%, 8-12%, 9-12%, or 10-12%, 10.5-11.6%.

The total amount of caffeine in the filling may be at least 0.01 wt. %, 0.02 wt. %, 0.03 wt. %, 0.04 wt. %, 0.05 wt. % by weight of the filling. The total amount of caffeine in the filling may be no more than 0.15 wt. %, 0.14 wt. %, 0.13 wt. %, 0.12 wt. %, 0.11 wt. %, 0.10 wt. %, 0.09 wt. %, 0.08 wt. % by weight of the filling.

The total amount of caffeine in the first solution may be at least 0.01 wt. %, 0.02 wt. %, 0.03 wt. %, 0.04 wt. %, 0.05 wt. % by weight of the first solution. The total amount of caffeine in the filling may be no more than 0.15 wt. %, 0.14 wt. %, 0.13 wt. %, 0.12 wt. %, 0.11 wt. %, 0.10 wt. %, 0.09 wt. %, 0.08 wt. % by weight of the first solution.

The total amount of caffeine in the first solution may be from 0.01-0.15 wt. %, 0.02-0.14 wt. %, 0.03-0.13 wt. %, 0.04-0.12 wt. %, 0.04-0.11 wt. %, 0.04-0.10 wt. %, 0.04-0.09 wt. %, 0.05-0.09 wt. % or 0.06-0.08 wt. % by weight of the first solution.

The first solution may comprise less than 14 wt. %, 13 wt. %, 12 wt. %, 11 wt. %, 10 wt. %, 9 wt. %, 8 wt. %, 7 wt. %, 6 wt. %, 5 wt. %, 4 wt. %, 3 wt. %, 2 wt. %, 1 wt. %, 0.9 wt. %, 0.8 wt. %, 0.7 wt. %, 0.6 wt. %, 0.5 wt. %, 0.4 wt. %, 0.3 wt. %, 0.2 wt. % or less than 0.1 wt. % sugars.

In some embodiments the first solution may be essentially free from or free from sugar.

In some embodiments, the first solution may comprise less than 10, 5, 4, 3, 2, 1 or 0.5 wt. % sucrose, and comprise substantially no sucrose or no sucrose.

In some embodiments, the first solution may comprise less than 10, 5, 4, 3, 2, 1 or 0.5 wt. % glucose, and comprise substantially no glucose or no glucose.

Preferably, the first solution does not comprise a hydrocolloid.

In some embodiments, the first solution does not comprise a polysaccharide selected from the group consisting of alginate, low methoxy pectin, guar gum and combinations thereof.

The first solution may comprise coffee.

The coffee may be caffeinated and/or decaffeinated.

The coffee may be a liquid coffee, an instant soluble coffee, spray dried coffee, freeze dried coffee, a blend of freeze dried soluble coffee, roast and ground coffee, and/or microground roast and ground coffee.

Preferably, the coffee is a liquid coffee.

The liquid coffee may be a liquid coffee concentrate.

The liquid coffee may be derived from roast and ground coffee.

In some embodiments, the roast and ground coffee may be derived from pure Arabica whole coffee beans.

In some embodiments, the roast and ground coffee may be derived from pure Robusta whole coffee beans.

In other embodiments, the roast and ground coffee may be derived from a mixture of Arabica and Robusta whole coffee beans.

The coffee may be present in an amount of at least 1 wt. % or at least 2, 3, 4, 5, 6, or at least 7 wt. % by weight of the first solution. In some embodiments, the coffee may be present in an amount of no more than 20 wt. % by weight of the first solution, or less than 19, 18, 17, 16, 15, 14, 13, 12, 11, 10, 9, or no more than 8 wt. % by weight of the first solution.

In some embodiments, the coffee may be present in an amount of 1-20 wt. % by weight of the first solution, or 1-19, 1-18, 1-17, 1-16, 1-15, 2-15, 3-15, 4-15, 4-14, 4-13, 4-12, 5-11, 5-10, 6-9, or 6-8 wt. % by weight of the first solution.

The first solution may have total dissolved coffee solids amount of at least 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, 4.9%, 5%.

The first solution may have total dissolved coffee solids amount of no more than 6%, 5.9%, 5.8%, 5.7%, 5.6%, 5.5%, 5.4%, 5.3%, 5.2%, 5.1%, 5.0%, 4.9%, 4.8%, 4.7%, 4.6%, 4.5%, 4.4%, 4.3%, 4.2%, 4.1%, 4.0%, 3.9%, 3.8%, 3.7%, 3.6%, 3.5%, 3.4%, 3.3%, 3.2%, 3.1% or no more than 3.0% or 5.1%, 5.2%, 5.3%, 5.4%, 5.5%, 5.6%, 5.7%, 5.8%, 5.9% or at least 6%.

Preferably, the first solution may have total dissolved coffee solids amount of 1.0-7.0%, 1-7.0%, 1.5-7.0%, 1.5-6.0%, 1.5-5.5%, 1.5-5.0%, 1.5-5.0%, 1.5-4.5%, 1.5-4.0%, 1.5-3.5%, or 1.5-3.0%, 1.5-2.5%.

The first solution may comprise a non-dairy creamer.

In such an embodiment, the first solution may comprise a fat in an amount of at least 6, 7, 8, 9, 10, 11, 12, 13, 14, 15, 16, 17, 18, 19, or at least 20 wt. % by weight of the first solution. In some embodiments, the fat may be present in an amount of no more than 40 wt. % by weight of the first solution or no more than 39, 38, 37, 36, 35, 34, 33, 32, 31, 30, 29, 28, 27, 26, 25, 24, 23, 22, 21, or no more than 20 wt. % by weight of the first solution.

In some embodiments, the fat may be present in an amount of 5-40 wt. % by weight of the first solution, or 6-35, 7-35, 8-35, 9-35, 10-35, 11-35, 12-35, 13-35, 14-35, 15-35, 16-35, 17-35, 18-35, 19-35, or 20-30 wt. % by weight of the first solution.

The non-dairy creamer may contain from about 0.1-95, 10-95, 15-95, 20-95, 25-95, 30-95, 35-95, 40-95, 45-95, 50-95, 55-95, 60-95, 65-95, 70-95, 75-95, 80-95, 85-95, 80-90, 85-90 wt. % of fats by weight of the non-dairy creamer.

The fat may be a vegetable fat.

The vegetable fat may be derived from a coconut, cocoa bean, palm fruit, sunflower seeds, soybean seeds, palm kernel, cotton seeds, canola seeds, olives, safflower seeds, or any combination thereof.

Preferably, the vegetable fat is derived from a coconut.

The vegetable fat may be a vegetable oil and/or a vegetable butter.

The vegetable oil may be a partially or wholly hydrogenated oil.

The vegetable oil may be a refined oil.

The vegetable oil and/or vegetable butter may comprise 50-100 wt. %, more preferably 70-100 wt. % and most preferably 90-100 wt. % of triglycerides.

The triglycerides of the vegetable oil and/or vegetable butter may have a lauric acid content of from about 5-60, 25-60, 40-60, or 40-50 wt. %, by weight of the total fatty acid content.

The triglycerides of the vegetable oil and/or vegetable butter may have a palmitic acid content of from about 1-45, 1-40, 1-30, 1-20, 1-15, or 1-10 wt. % by weight of the total fatty acid content.

The triglycerides of the vegetable oil and/or vegetable butter may have a myristic acid content of from about 2-30, 5-30, 5-25, 5-20, or 10-20 wt. % by weight of the total fatty acid content.

The triglycerides of the vegetable oil and/or vegetable butter may have a stearic acid content of from about 0.1-40, 0.1-35, or 1-3 wt. % by weight of the total fatty acid content.

The triglycerides of the vegetable oil and/or vegetable butter may have a linoleic acid content of from about 0.1-10, 0.5-5, or 1-3 wt. % by weight of the total fatty acid content.

The triglycerides of the vegetable oil and/or vegetable butter may have a caprylic acid content of from 1-30, 1-25, 1-20, 1-15, 1-10, 2-10, 3-10, 4-10, or 5-10 wt. % by weight of the total fatty acid content.

The triglycerides of the vegetable oil and/or vegetable butter may have a capric acid content of from 1-30, 1-25, 1-20, 1-15, 1-10, 2-10, 3-10, 4-10, or 5-10 wt. % by weight of the total fatty acid content.

The triglycerides of the vegetable oil and/or vegetable butter may have an oleic acid content of from 1-40, 1-25, 1-20, 1-15, 1-10, 1-8, or 2-8 wt. %, by weight of the total fatty acid content.

The triglycerides of the vegetable oil and/or vegetable butter may have a lauric acid content of from about 5-60 wt. % by weight of the total fatty acid content; a palmitic acid content of from about 1-45 wt. % by weight of the total fatty acid content; and a myristic acid content of from about 2-30 wt. % by weight of the total fatty acid content.

The triglycerides of the vegetable oil and/or vegetable butter may have a lauric acid content of from 40-50 wt. % by weight of the total fatty acid content; a palmitic acid content of from 1-10 wt. % by weight of the total fatty acid content; and a myristic acid content of from 10-20 wt. % by weight of the total fatty acid content.

The triglycerides of the vegetable oil and/or vegetable butter may have a stearic acid content of from about 0.1-40 wt. %, by weight of the total fatty acid content; a palmitic acid content of from about 1-45 wt. % by weight of the total fatty acid content; and an oleic acid content of from about 2-40 wt. % by weight of the total fatty acid content.

The triglycerides of the vegetable oil and/or vegetable butter may have a stearic acid content of from about 30-40 wt. % by weight of the total fatty acid content; a palmitic acid content of from about 20-30 wt. % by weight of the total fatty acid content; and an oleic acid content of from about 30-40 wt. % by weight of the total fatty acid content.

In some embodiments, the triglycerides of the vegetable oil and/or vegetable butter may have a lauric acid content of from about 5-60 wt. % by weight of the total fatty acid content; a palmitic acid content of from about 1-45 wt. % by weight of the total fatty acid content; a myristic acid content of from about 2-30 wt. % by weight of the total fatty acid content; a stearic acid content of from about 0.1-5 wt. % by weight of the total fatty acid content; a linoleic acid content of from about 0.1-10 wt. % by weight of the total fatty acid content; a caprylic acid content of from 1-30 wt. %, by weight of the total fatty acid content; a capric acid content of from 1-30 wt. % by weight of the total fatty acid content; and an oleic acid content of from 1-30 wt. % by weight of the total fatty acid content.

Preferably, the triglycerides of the vegetable oil and/or vegetable butter have a lauric acid content of from 40-50 wt. % by weight of the total fatty acid content; a palmitic acid content of from 1-10 wt. % by weight of the total fatty acid content; a myristic acid content of from 10-20 wt. % by weight of the total fatty acid content; a stearic acid content of from 1-3 wt. % by weight of the total fatty acid content; a linoleic acid content of from 1-3 wt. % by weight of the total fatty acid content; a caprylic acid content of from 5-10 wt. % by weight of the total fatty acid content; capric acid content of from 5-10 wt. % by weight of the total fatty acid content; and an oleic acid content of from 2-8 wt. % by weight of the total fatty acid content.

The vegetable butter may be soybean butter, coconut butter, palm butter, canola butter, sunflower butter, and other butters, or a combination thereof.

The vegetable oil may be soybean oil, coconut oil, palm oil, palm kernel oil, cotton seed oil, canola oil, olive oil, sunflower oil, safflower oil and other oils, or a combination thereof.

Preferably, the vegetable oil is a coconut oil. More preferably, the vegetable oil is a refined coconut oil.

The non-dairy creamer may also include an emulsifier.

In such an embodiment, the emulsifier may be present in an amount of no more than 10 wt. % by weight of the first solution or no more than 9, 8, 7, 6, 5, 4, 3, 2, 1, 0.9, 0.8, 0.7, 0.6, 0.5, 0.4, 0.3, 0.2, or no more than 0.1 wt. % by weight of the first solution.

In some embodiments, the emulsifier may be present in an amount of 0.1-10 wt. % by weight of the first solution, or 0.2-10, 0.3-10, 0.4-9, 0.5-8 0.6-7, 0.7-6, 0.8-5, 0.9-4, 1-3, or 1-2 wt. % by weight of the first solution.

The emulsifier may be a monoglyceride, diglyceride, lecithin, diacetyl tartaric acid esters of mono-diglycerides (DATEM), stearoyl lactylates, modified food starches, polysorbates, polysorbate 20, polysorbate 60, polysorbate 80, PGA, and mixtures thereof.

The non-dairy creamer may contain from about 0.1-10, 0.2-10, 0.3-10, 0.4-10, 0.5-10, 0.5-8, 0.5-5, 0.6-5, 0.7-5, 0.8-5, 0.9-5, 1-5, 1.5-4, 1.5-3.5, 2-3.5, 2-3 wt. % of an emulsifier by weight of the non-dairy creamer.

The non-dairy creamer may be a liquid, powder, gel, and/or emulsion.

Preferably, the non-dairy creamer is an emulsion.

The non-dairy creamer may contain from about 0.1-10, 0.2-10, 0.3-10, 0.4-10, 0.5-10, 0.5-8, 0.5-5, 0.6-5, 0.7-5, 0.8-5, 0.9-5, 1-5, 1.5-4, 1.5-3.5, 2-3.5, 2-3 wt. % of an emulsifier by weight of the non-dairy creamer.

The non-dairy creamer may be present in an amount of at least 1 wt. % or at least 2, 3, 4, 5, 6, 7, 8, 9, 10, 11, 12, 13, 14, or at least 15 wt. % by weight of the first solution. In some embodiments, the non-dairy creamer may be present in an amount of less than 30 wt. % by weight of the first solution, or less than 29, 28, 27, 26, 25, 24, 23, 22, 21, 20, 19, 18, 17, 16, 15, 14, 13, 12, 11, 10, 9, or no more than 8 wt. % by weight of the first solution.

In some embodiments, the non-dairy creamer may be present in an amount of 1-30 wt. % by weight of the first solution, or 5-30, 10-30, 11-30, 12-30, 13-30, 14-30, 15-30, 15-29, 15-28, 15-27, 15-26, 15-25, 16-25, 17-25, 18-25, 19-25, 15-24, 15-23, 15-22, 16-24, 17-23 or 18-22 wt. % by weight of the first solution.

The first solution may comprise one or more further ingredients. The further ingredients may be a flavouring, sweetener, organic acids, nutraceutical, colouring agent and/or thickening agent.

The thickening agent may include starch, modified starch, xanthan, galactomannans, such as guar gum and locust bean gum (LBG), gum Arabic, gum karaya, gum tragacanth and carboxymethyl cellulose (CMC).

The thickening agent may be present in an amount of no more than 10 wt. % by weight of the first solution or no more than 9, 8, 7, 6, 5, 4, 3, 2, 1, 0.9, 0.8, 0.7, 0.6, 0.5, 0.4, 0.3, 0.2, or no more than 0.1 wt. % by weight of the first solution.

In some embodiments, the thickening agent may be present in an amount of 0.01-5 wt. % by weight of the first solution, or 0.01-4, 0.02-3, 0.03-2, 0.04-2, 0.05-2, 0.05-1, 0.05-0.5, 0.05-0.4, 0.05-0.3, 0.05-0.3, 0.06-1.4, 0.07-0.3, 0.08-0.2, or 0.09-0.1 wt. % by weight of the first solution.

The flavouring may include chocolate powder (or cocoa) or a flavouring selected from chocolate (or cocoa), vanilla, strawberry, cinnamon, mint, hazelnut, caramel, biscuit, gingerbread, fruit flavouring, vegetable flavouring, spices, pumpkin spice, pistachio, eggnog, Irish Cream, alcoholic beverage flavouring, liqueurs, beer, rum, wine, gin cognac, plant and herb flavourings, agrimony, alfalfa, aloe vera, amaranth, angelica, anise, barberry, basil, bayberry, bee pollen, birch, bistort, blackberry, black cohosh, black walnut, blessed thistle, blue cohosh, blue vervain, boneset, borage, buchu, buckthorn, bugleweed, burdock, capsicum, cayenne, caraway, catnip, celery, centaury, chamomile, chaparral, chickweed, chinchona, cloves, coltsfoot, comfrey, cornsilk, couch grass, cramp bark, culver's root, cyani, cornflower, damiana, dandelion, devils claw, dong quai, echinacea, elecampane, ephedra, eucalyptus, evening primrose, eyebright, false unicorn, fennel, fenugreek, figwort, flaxseed, guarana, garlic, gentian, ginger, ginkgo, ginseng, golden seal, gotu kola, gum weed, hawthorn, hops, horehound, horseradish, horsetail, hoshouwu, hydrangea, hyssop, iceland moss, irish moss, jojoba, juniper, kelp, lady's slipper, lemon grass, licorice, lobelia, mandrake, marigold, marjoram, marshmallow, mistletoe, mullein, mustard, myrrh, nettle, oatstraw, Oregon grape, papaya, parsley, passion flower, peach, pennyroyal, peppermint, periwinkle, plantain, pleurisy root, pokeweed, prickly ash, psyllium, quassia, queen of the meadow, red clover, red raspberry, redmond clay, rhubarb, rose hips, rosemary, rue, safflower, saffron, sage, St. John's wort, sarsaparilla, sassafras, saw palmetto, scullcap, senega, senna, shepherd's purse, slippery elm, spearmint, spikenard, squawvine, stillingia, strawberry, taheebo, uva ursi, valerian, violet, watercress, white oak bark, white pine bark, wild cherry, wild lettuce, wild yam, willow, wintergreen, witch hazel, wood betony, wormwood, yarrow, yellow dock, yerba santa, yucca, lavender, thyme, or a combination of two or more thereof.

The flavouring may be present in an amount of no more than 10 wt. % by weight of the first solution or no more than 9, 8, 7, 6, 5, 4, 3, 2, 1, 0.9, 0.8, 0.7, 0.6, 0.5, 0.4, 0.3, 0.2, or no more than 0.1 wt. % by weight of the first solution.

In some embodiments, the flavouring may be present in an amount of 0.01-5 wt. % by weight of the first solution, or 0.01-4, 0.02-3, 0.03-1, 0.04-1, 0.05-1, 0.05-0.9, 0.05-0.8, 0.05-0.7, 0.05-0.6, 0.05-0.5, 0.06-0.4, 0.07-0.3, 0.08-0.2, or 0.09-0.2 wt. % by weight of the first solution.

The sweetener may be selected from a carbohydrate-based sweetener or a non-carbohydrate based sweetener. The carbohydrate-based sweetener may be a sugar substitutes like e.g. polyols such as sorbitol, mannitol, xylitol or combinations thereof, maltodextrins, dried glucose syrups, malt extracts, starches, trehalose, raftiline, raftilose, galactose, honey powders, and mixtures of same. The non-carbohydrate based sweetener may be an artificial sweetener like e.g. Splenda®, Acesulfame K®, or aspartame, and mixtures of the same. The non-carbohydrate based sweetener may be a natural sweetener, such as stevia.

The sweetener may be present in an amount of no more than 10 wt. % by weight of the first solution or no more than 9, 8, 7, 6, 5, 4, 3, 2, 1, 0.9, 0.8, 0.7, 0.6, 0.5, 0.4, 0.3, 0.2, or no more than 0.1 wt. % by weight of the first solution.

In some embodiments, the sweetener may be present in an amount of 0.1-10 wt. % by weight of the first solution, or 0.2-10, 0.3-10, 0.4-9, 0.5-8 0.6-7, 0.7-6, 0.8-5, 0.9-4, 1-3, or 1-2 wt. % by weight of the first solution.

The organic acid may be citric acid, lactic acid, acetic acid, tannic acid, malic acid, and/or tartaric acid.

The organic acid may be present in an amount of no more than 10 wt. % by weight of the first solution or no more than 9, 8, 7, 6, 5, 4, 3, 2, 1, 0.9, 0.8, 0.7, 0.6, 0.5, 0.4, 0.3, 0.2, or no more than 0.1 wt. % by weight of the first solution.

In some embodiments, the organic acid may be present in an amount of 0.01-5 wt. % by weight of the first solution, or 0.01-4, 0.02-3, 0.03-2, 0.04-2, 0.05-2, 0.05-1, 0.05-0.5, 0.05-0.4, 0.05-0.3, 0.05-0.3, 0.06-1.4, 0.07-0.3, 0.08-0.2, or 0.1-0.2 wt. % by weight of the first solution.

The nutraceutical may be selected from the group consisting of ascorbic acid (vitamin C), B vitamins, biotin, fat soluble vitamins, folic acid, HCA (hydroxycitric acid), inositol, pyruvate, mineral ascorbates, mixed tocopherols, niacin (vitamin B3), orotic acid, PABA (para-aminobenzoic acid), pantothenates, pantothenic acid (vitamin B5), pyridoxine hydrochloride (vitamin B6), riboflavin (vitamin B2), synthetic vitamins, thiamine (vitamin B1), tocotrienols, vitamin A, vitamin D, vitamin E, vitamin F, vitamin K, vitamin oils, vitamin premixes, vitamin-mineral premixes, water soluble vitamins, chromium, cobalt, copper, fluorine, iodine, magnesium, manganese, molybdenum, nickel, phosphorous, iron, potassium, selenium, silicon, sodium, strontium, sulfur, vanadium, zinc, and combinations thereof.

The nutraceutical may be present in an amount of no more than 10 wt. % by weight of the first solution or no more than 9, 8, 7, 6, 5, 4, 3, 2, 1, 0.9, 0.8, 0.7, 0.6, 0.5, 0.4, 0.3, 0.2, or no more than 0.1 wt. % by weight of the first solution.

In some embodiments, the nutraceutical may be present in an amount of 0.01-5 wt. % by weight of the first solution, or 0.01-4, 0.02-3, 0.03-1, 0.04-1, 0.05-1, 0.05-0.9, 0.05-0.8, 0.05-0.7, 0.05-0.6, 0.05-0.5, 0.06-0.4, 0.07-0.3, 0.08-0.2, or 0.09-0.2 wt. % by weight of the first solution.

The colouring agent may be selected from the group consisting of edible glitter and/or any edible food colouring.

The use of a colouring agent may improve the appearance of the bead.

The colouring agent may be present in an amount of no more than 10 wt. % by weight of the first solution or no more than 9, 8, 7, 6, 5, 4, 3, 2, 1, 0.9, 0.8, 0.7, 0.6, 0.5, 0.4, 0.3, 0.2, or no more than 0.1 wt. % by weight of the first solution.

In some embodiments, the colouring agent may be present in an amount of 0.01-5 wt. % by weight of the first solution, or 0.01-4, 0.02-3, 0.03-1, 0.04-1, 0.05-1, 0.05-0.9, 0.05-0.8, 0.05-0.7, 0.05-0.6, 0.05-0.5, 0.06-0.4, 0.07-0.3, 0.08-0.2, or 0.09-0.2 wt. % by weight of the first solution.

The first solution may comprise water in an amount of at least 5 wt. % by weight of the first solution, or at least 10, 15, 20, 25, 30, 35, 40, 45, or at least 50 wt. % by weight of the first solution. In some embodiments, the first solution may comprise water in an amount of no more than 80 wt. % by weight of the first solution or no more than 75, 70, 65, 60, 55, or no more than 50 wt. % by weight of the first solution.

In some embodiments, the first solution may comprise water in an amount of 30-80 wt. % by weight of the first solution, or 35-75, 40-65, 45-65, or 45-60 wt. % by weight of the first solution.

The polysaccharide of the second solution may be a hydrocolloid.

The polysaccharide of the second solution may comprise a polysaccharide selected from the group consisting of alginate, low methoxy pectin, guar gum and combinations thereof.

Preferably, the polysaccharide is alginate. More preferably, the alginate is an alkali metal alginate

Preferably, the alginate is sodium alginate.

The polysaccharide may be present in an amount of no more than 10 wt. % by weight of the second solution or no more than 9, 8, 7, 6, 5, 4, 3, 2, 1, 0.9, 0.8, 0.7, 0.6, 0.5, 0.4, 0.3, 0.2, or no more than 0.1 wt. % by weight of the second solution.

In some embodiments, the polysaccharide may be present in an amount of 0.1-5 wt. % by weight of the second solution, or 0.1-4, 0.1-3, 0.1-2, 0.1-1.5, 0.1-1, 0.2-0.9, 0.2-0.8, 0.2-0.7, 0.3-0.7, or from 0.3-0.6 wt. % by weight of the second solution.

The second solution may comprise water.

Preferably, the water is deionised.

The second solution may comprise water in an amount of at least 90 wt. % by weight of the first solution, or at least 95, 96, 97, 98, 99, 99.1, 99.2, 99.3, or at least 99.4 wt. % by weight of the second solution.

In a third aspect of the present invention there is provided a product comprising one or more edible beads according to the first aspect of the present invention.

The product may comprise a beverage liquid.

In some embodiments, the beverage liquid may be coffee, tea, infusion of one or more plants, herbs, fruits or spices, chocolate, carbonated liquids (such as soda, pop and/or sparkling water), flavoured water, alcoholic liquid (such as beer, wine, fortified wine or a distilled spirit), and/or juices (such as a fruit juice, berry juice and/or a vegetable juice).

In such an embodiment, the edible beads may be dispersed in the beverage liquid.

In one embodiment, the product may comprise a food product.

The food product may be a dairy product, savoury product, confectionery product, wholegrain product frozen product, and/or baked product.

The dairy product may be ice cream, yoghurt, milk, cream and/or kefir.

The baked product may be cakes, doughnuts, wafers, pastries, tarts, and/or cookie.

The frozen product may be a frozen dessert such as a sorbet, ice cream, frozen fruit juice, mousse and/or frozen flavoured water.

The confectionery product may be a chocolate product.

The wholegrain product may be oatmeal and/or cereal.

In such an embodiment, the edible bead may be disposed on the food product.

Alternatively, the product may comprise one or more edible beads dispersed in an aqueous solution.

The aqueous solution may be a preservation solution.

By ‘preservation solution’ it is meant a solution which allows the beads to be stored for a period of time without the beads degrading in quality, taste, texture and/or form. The period of time may be at least 1, 5, 10 20, 30 days or at least 1, 2, 3, 6, 7, 8, 9, 10, 11, or at least 12 months.

Preferably, the preservation solution does not comprise a metal salt.

The inventors found that by not incorporating a metal salt in the preservation solution, the edible beads did not undergo further gelation when stored in the preservation solution.

The preservation solution may comprise at least one soluble dietary fibre.

The at least one soluble dietary fibre may comprise at least one dietary fibre selected from the group consisting of inulin, fructooligosaccharide (FOS), levan, polydextrose, kestose, nystose, raffinose, galacto-oligosaccharides, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, milk oligosaccharides, 2′-fucosyl lactose, lacto-n-neotetraose, glucan (i.e., glucose containing) oligosaccharides, cello-oligosaccharides (or cellodextrins), resistant dextrins (e.g., soluble corn fiber, soluble wheat fiber, soluble tapioca fiber, soluble pea fibre), nigero-oligosaccharides, nigerotriose, nigerotetraose, kojitriose, kojitetraose, dextrans, beta glucans, lichenan, isolichenan, and combinations thereof. In some embodiments the further soluble dietary fibre may comprises tapioca fibre and/or pea fibre.

Preferably, the at least one soluble dietary fibre is inulin galacto-oligosaccharide, polydextrose and/or fructooligosaccharide.

The at least one soluble dietary fibre may be present in an amount of at least 5 wt. % by weight of the preservation solution, or at least 6, 7, 8, 9, 10, 11, 12, 13, 14, 15, 16, 17, 18, 19, or at least 20 wt. % by weight of the preservation solution. In some embodiments, the at least one soluble dietary fibre may be present in an amount of no more than 40 wt. % by weight of the preservation solution or no more than 39, 38, 37, 36, 35, 34, 33, 32, 31, 30, 29, 28, 27, 26, 25, 24, 23, 22, 21, or no more than 20 wt. % by weight of the preservation solution.

In some embodiments, the at least one soluble dietary fibre may be present in an amount of 5-40 wt. % by weight of the preservation solution, or 6-35, 7-35, 8-35, 9-35, 10-35, 11-35, 12-35, 13-35, 14-35, 15-35, 16-35, 17-35, 18-35, 19-35, or 20-30 wt. % by weight of the preservation solution.

The preservation solution may comprise one, two, three, four, five, six, seven, eight, nine or ten soluble dietary fibres.

In some embodiments, the preservation solution may comprise a plurality of soluble dietary fibres.

The at least one soluble dietary fibre may be a short chain fibre and/or medium chain fibre.

The short chain fibre may have a degree of polymerisation of no more than 10, 9, 8, 7, 6, 5, 4, 3 or no more than 2.

In some embodiments, short chain fibre may have a degree of polymerisation of from 2-10, 2-9, or from 2-8.

The medium chain fibre may have a degree of polymerisation of no more than 60, 50, 40, 30, 20, or no more than 15.

In some embodiments, the medium chain fibre may have a degree of polymerisation of from 8-60, 8-50, 8-40, 8-30, 8-20, 10-60, 15-60, 20-60, 20-50, or from 20-40.

Preferably, the at least one soluble fibre is a short and/or medium chain inulin.

The short chain inulin may have a degree of polymerisation of no more than 10, 9, 8, 7, 6, 5, 4, 3 or no more than 2.

In some embodiments, short chain inulin may have a degree of polymerisation of from 2-10, 2-9, or from 2-8.

The medium chain inulin may have a degree of polymerisation of no more than 60, 50, 40, 30, 20, or no more than 15.

In some embodiments, the medium chain inulin may have a degree of polymerisation of from 8-60, 8-50, 8-40, 8-30, 8-20, 10-60, 15-60, 20-60, 20-50, or from 20-40.

The preservation solution may comprise a tea extract.

The tea extract may be caffeinated and/or decaffeinated.

The tea extract may be an extraction produced from the leaves of any part of a plant.

The plant may be selected from the group consisting of fruits, herbs, medicinal plants, tea, vegetables and spices, including mixtures thereof, such as, for example, mixtures of herbs, vegetables and/or spices.

The fruits, herbs, medicinal plants, tea, vegetables and spices may be selected from example selected from artemisia, balm, basil, chai, chamomile, chive, cloves, coffee, coriander, dill, garlic, ginger, ginseng, gingko, jasmine, lavender, matcha, mint, orange blossom, oregano, persil, rooibos, Rosa centifolia, rosemary, thyme, turmeric, sage, pepper, chili pepper, rose, Stevia rebaudiana, tarragon, white tea, yellow tea, green tea, oolong tea, black tea, pu-erh tea, vanilla, red or green vine, violet and/or willow.

The tea extract may also comprise added aromas, fruit parts and spices.

The tea extract may be black tea, white tea, fruit tea, green tea, rooibos tea, oolong tea, chamomile tea, peppermint tea, ginger tea, cinnamon tea, lemongrass tea, rosemary tea, pu-erh tea, olive leaf tea, barley tea, liquorice tea, eucalyptus tea, gingko tea, sage tea, raspberry tea, valerian root tea, elderberry flower tea, lavender tea, turmeric tea, purple tea, pine needle tea, echinacea tea, honeybush tea, rose tea, jasmine tea, cranberry tea, dandelion tea, guava tea, thyme tea, matcha tea, chai tea, lemon balm tea, and any mixture thereof.

The tea extract may be in the form of a liquid tea extract, infusion, an instant soluble tea extract, spray dried tea extract, freeze dried tea extract, and/or a blend of freeze dried soluble tea extract.

Preferably, the tea extract is in the form of a liquid tea extract.

The liquid tea extract may be a liquid tea extract concentrate.

The tea extract may be present in an amount of at least 1 wt. % or at least 2, 3, 4, 5, 6, or at least 7 wt. % by weight of the preservation solution. In some embodiments, the tea extract may be present in an amount of no more than 20 wt. % by weight of the preservation solution, or less than 19, 18, 17, 16, 15, 14, 13, 12, 11, or no more than 10 wt. % by weight of the preservation solution.

In some embodiments, the tea extract may be present in an amount of 1-20 wt. % by weight of the preservation solution, or 1-19, 1-18, 1-17, 1-16, 1-15, 2-15, 3-15, 4-15, 4-14, 4-13, 4-12, 5-12, 6-12, 7-12, or 9-11 wt. % by weight of the preservation solution.

The preservation solution may have a total dissolved tea solids amount of at least 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, 4.9%, 5%, 6%, 7%, 8%, 9%, or at least 10%.

The preservation solution may have a total dissolved tea solids amount of no more than 20%, 19%, 18%, 17%, 16%, 15%, 14%, 13%, 12%, 11%, or no more than 10%.

Preferably, the preservation solution may have a total dissolved tea solids amount of 1.0-20%, 1-15%, 5-15%, 6-15%, 7-15%, 8-15%, 6-14%, 7-13%, 8-12%, 9-12%, or 10-12%, 10.5-11.6%.

The preservation solution may comprise less than 14 wt. %, 13 wt. %, 12 wt. %, 11 wt. %, 10 wt. %, 9 wt. %, 8 wt. %, 7 wt. %, 6 wt. %, 5 wt. %, 4 wt. %, 3 wt. %, 2 wt. %, 1 wt. %, 0.9 wt. %, 0.8 wt. %, 0.7 wt. %, 0.6 wt. %, 0.5 wt. %, 0.4 wt. %, 0.3 wt. %, 0.2 wt. % or less than 0.1 wt. % sugars.

In some embodiments the preservation solution may be essentially free from or free from sugar.

In some embodiments, the preservation solution may comprise less than 10, 5, 4, 3, 2, 1 or 0.5 wt. % sucrose, and comprise substantially no sucrose or no sucrose.

In some embodiments the preservation solution may comprise less than 10, 5, 4, 3, 2, 1 or 0.5 wt. % glucose, and comprise substantially no glucose or no glucose.

Preferably, the preservation solution does not comprise a hydrocolloid.

In some embodiments, the preservation solution does not comprise a polysaccharide selected from the group consisting of alginate, low methoxy pectin, guar gum and combinations thereof. Preferably, the preservation solution does not comprise an alginate.

More preferably, the preservation solution does not comprise sodium alginate.

The preservation solution may comprise coffee.

The coffee may be caffeinated and/or decaffeinated.

The coffee may be a liquid coffee, an instant soluble coffee, spray dried coffee, freeze dried coffee, a blend of freeze dried soluble coffee, roast and ground coffee, and/or microground roast and ground coffee.

Preferably, the coffee is a liquid coffee.

The liquid coffee may be a liquid coffee concentrate.

The liquid coffee may be derived from roast and ground coffee.

In some embodiments, the roast and ground coffee may be derived from pure Arabica whole coffee beans.

In some embodiments, the roast and ground coffee may be derived from pure Robusta whole coffee beans.

In other embodiments, the roast and ground coffee may be derived from a mixture of Arabica and Robusta whole coffee beans.

The coffee may be present in an amount of at least 1 wt. % or at least 2, 3, 4, 5, 6, or at least 7 wt. % by weight of the preservation solution. In some embodiments, the coffee may be present in an amount of no more than 20 wt. % by weight of the preservation solution, or less than 19, 18, 17, 16, 15, 14, 13, 12, 11, 10, 9, or no more than 8 wt. % by weight of the preservation solution.

In some embodiments, the coffee may be present in an amount of 1-20 wt. % by weight of the preservation solution, or 1-19, 1-18, 1-17, 1-16, 1-15, 2-15, 3-15, 4-15, 4-14, 4-13, 4-12, 5-11, 5-10, 6-9, or 6-8 wt. % by weight of the preservation solution.

The preservation solution may have total dissolved coffee solids amount of at least 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, 4.9%, 5%.

The preservation solution may have total dissolved coffee solids amount of no more than 6%, 5.9%, 5.8%, 5.7%, 5.6%, 5.5%, 5.4%, 5.3%, 5.2%, 5.1%, 5.0%, 4.9%, 4.8%, 4.7%, 4.6%, 4.5%, 4.4%, 4.3%, 4.2%, 4.1%, 4.0%, 3.9%, 3.8%, 3.7%, 3.6%, 3.5%, 3.4%, 3.3%, 3.2%, 3.1% or no more than 3.0% or 5.1%, 5.2%, 5.3%, 5.4%, 5.5%, 5.6%, 5.7%, 5.8%, 5.9% or at least 6%.

Preferably, the preservation solution may have total dissolved coffee solids amount of 1.0-7.0%, 1-7.0%, 1.5-7.0%, 1.5-6.0%, 1.5-5.5%, 1.5-5.0%, 1.5-5.0%, 1.5-4.5%, 1.5-4.0%, 1.5-3.5%, or 1.5-3.0%, 1.5-2.5%.

The preservation solution may comprise a non-dairy creamer.

In such an embodiment, the preservation solution may comprise a fat in an amount of at least 6, 7, 8, 9, 10, 11, 12, 13, 14, 15, 16, 17, 18, 19, or at least 20 wt. % by weight of the preservation solution. In some embodiments, the fat may be present in an amount of no more than 40 wt. % by weight of the preservation solution or no more than 39, 38, 37, 36, 35, 34, 33, 32, 31, 30, 29, 28, 27, 26, 25, 24, 23, 22, 21, or no more than 20 wt. % by weight of the preservation solution.

In some embodiments, the fat may be present in an amount of 5-40 wt. % by weight of the preservation solution, or 6-35, 7-35, 8-35, 9-35, 10-35, 11-35, 12-35, 13-35, 14-35, 15-35, 16-35, 17-35, 18-35, 19-35, or 20-30 wt. % by weight of the preservation solution.

The non-dairy creamer may contain from about 0.1-95, 10-95, 15-95, 20-95, 25-95, 30-95, 35-95, 40-95, 45-95, 50-95, 55-95, 60-95, 65-95, 70-95, 75-95, 80-95, 85-95, 80-90, 85-90 wt. % of fats by weight of the non-dairy creamer.

The fat may be a vegetable fat.

The vegetable fat may be derived from a coconut, cocoa bean, palm fruit, sunflower seeds, soybean seeds, palm kernel, cotton seeds, canola seeds, olives, safflower seeds, or any combination thereof.

Preferably, the vegetable fat is derived from a coconut.

The vegetable fat may be a vegetable oil and/or a vegetable butter.

The vegetable oil may be a partially or wholly hydrogenated oil.

The vegetable oil may be a refined oil.

The vegetable oil and/or vegetable butter may comprise 50-100 wt. %, more preferably 70-100 wt. % and most preferably 90-100 wt. % of triglycerides.

The triglycerides of the vegetable oil and/or vegetable butter may have a lauric acid content of from about 5-60, 25-60, 40-60, or 40-50 wt. %, by weight of the total fatty acid content.

The triglycerides of the vegetable oil and/or vegetable butter may have a palmitic acid content of from about 1-45, 1-40, 1-30, 1-20, 1-15, or 1-10 wt. % by weight of the total fatty acid content.

The triglycerides of the vegetable oil and/or vegetable butter may have a myristic acid content of from about 2-30, 5-30, 5-25, 5-20, or 10-20 wt. % by weight of the total fatty acid content.

The triglycerides of the vegetable oil and/or vegetable butter may have a stearic acid content of from about 0.1-40, 0.1-35, or 1-3 wt. % by weight of the total fatty acid content.

The triglycerides of the vegetable oil and/or vegetable butter may have a linoleic acid content of from about 0.1-10, 0.5-5, or 1-3 wt. % by weight of the total fatty acid content.

The triglycerides of the vegetable oil and/or vegetable butter may have a caprylic acid content of from 1-30, 1-25, 1-20, 1-15, 1-10, 2-10, 3-10, 4-10, or 5-10 wt. % by weight of the total fatty acid content.

The triglycerides of the vegetable oil and/or vegetable butter may have a capric acid content of from 1-30, 1-25, 1-20, 1-15, 1-10, 2-10, 3-10, 4-10, or 5-10 wt. % by weight of the total fatty acid content.

The triglycerides of the vegetable oil and/or vegetable butter may have an oleic acid content of from 1-40, 1-25, 1-20, 1-15, 1-10, 1-8, or 2-8 wt. %, by weight of the total fatty acid content.

The triglycerides of the vegetable oil and/or vegetable butter may have a lauric acid content of from about 5-60 wt. % by weight of the total fatty acid content; a palmitic acid content of from about 1-45 wt. % by weight of the total fatty acid content; and a myristic acid content of from about 2-30 wt. % by weight of the total fatty acid content.

The triglycerides of the vegetable oil and/or vegetable butter may have a lauric acid content of from 40-50 wt. % by weight of the total fatty acid content; a palmitic acid content of from 1-10 wt. % by weight of the total fatty acid content; and a myristic acid content of from 10-20 wt. % by weight of the total fatty acid content.

The triglycerides of the vegetable oil and/or vegetable butter may have a stearic acid content of from about 0.1-40 wt. %, by weight of the total fatty acid content; a palmitic acid content of from about 1-45 wt. % by weight of the total fatty acid content; and an oleic acid content of from about 2-40 wt. % by weight of the total fatty acid content.

The triglycerides of the vegetable oil and/or vegetable butter may have a stearic acid content of from about 30-40 wt. % by weight of the total fatty acid content; a palmitic acid content of from about 20-30 wt. % by weight of the total fatty acid content; and an oleic acid content of from about 30-40 wt. % by weight of the total fatty acid content.

In some embodiments, the triglycerides of the vegetable oil and/or vegetable butter may have a lauric acid content of from about 5-60 wt. % by weight of the total fatty acid content; a palmitic acid content of from about 1-45 wt. % by weight of the total fatty acid content; a myristic acid content of from about 2-30 wt. % by weight of the total fatty acid content; a stearic acid content of from about 0.1-5 wt. % by weight of the total fatty acid content; a linoleic acid content of from about 0.1-10 wt. % by weight of the total fatty acid content; a caprylic acid content of from 1-30 wt. %, by weight of the total fatty acid content; a capric acid content of from 1-30 wt. % by weight of the total fatty acid content; and an oleic acid content of from 1-30 wt. % by weight of the total fatty acid content.

Preferably, the triglycerides of the vegetable oil and/or vegetable butter have a lauric acid content of from 40-50 wt. % by weight of the total fatty acid content; a palmitic acid content of from 1-10 wt. % by weight of the total fatty acid content; a myristic acid content of from 10-20 wt. % by weight of the total fatty acid content; a stearic acid content of from 1-3 wt. % by weight of the total fatty acid content; a linoleic acid content of from 1-3 wt. % by weight of the total fatty acid content; a caprylic acid content of from 5-10 wt. % by weight of the total fatty acid content; capric acid content of from 5-10 wt. % by weight of the total fatty acid content; and an oleic acid content of from 2-8 wt. % by weight of the total fatty acid content.

The vegetable butter may be soybean butter, coconut butter, palm butter, canola butter, sunflower butter, and other butters, or a combination thereof.

The vegetable oil may be soybean oil, coconut oil, palm oil, palm kernel oil, cotton seed oil, canola oil, olive oil, sunflower oil, safflower oil and other oils, or a combination thereof.

Preferably, the vegetable oil is a coconut oil. More preferably, the vegetable oil is a refined coconut oil.

The non-dairy creamer may also include an emulsifier.

In such an embodiment, the emulsifier may be present in an amount of no more than 10 wt. % by weight of the preservation solution or no more than 9, 8, 7, 6, 5, 4, 3, 2, 1, 0.9, 0.8, 0.7, 0.6, 0.5, 0.4, 0.3, 0.2, or no more than 0.1 wt. % by weight of the preservation solution.

In some embodiments, the emulsifier may be present in an amount of 0.1-10 wt. % by weight of the preservation solution, or 0.2-10, 0.3-10, 0.4-9, 0.5-8 0.6-7, 0.7-6, 0.8-5, 0.9-4, 1-3, or 1-2 wt. % by weight of the preservation solution.

The emulsifier may be a monoglyceride, diglyceride, lecithin, diacetyl tartaric acid esters of mono-diglycerides (DATEM), stearoyl lactylates, modified food starches, polysorbates, polysorbate 20, polysorbate 60, polysorbate 80, PGA, and mixtures thereof.

The non-dairy creamer may contain from about 0.1-10, 0.2-10, 0.3-10, 0.4-10, 0.5-10, 0.5-8, 0.5-5, 0.6-5, 0.7-5, 0.8-5, 0.9-5, 1-5, 1.5-4, 1.5-3.5, 2-3.5, 2-3 wt. % of an emulsifier by weight of the non-dairy creamer.

The non-dairy creamer may be a liquid, powder, gel, and/or emulsion.

Preferably, the non-dairy creamer is an emulsion.

The non-dairy creamer may be present in an amount of at least 1 wt. % or at least 2, 3, 4, 5, 6, 7, 8, 9, 10, 11, 12, 13, 14, or at least 15 wt. % by weight of the preservation solution. In some embodiments, the non-dairy creamer may be present in an amount of less than 30 wt. % by weight of the preservation solution, or less than 29, 28, 27, 26, 25, 24, 23, 22, 21, 20, 19, 18, 17, 16, 15, 14, 13, 12, 11, 10, 9, or no more than 8 wt. % by weight of the preservation solution.

In some embodiments, the non-dairy creamer may be present in an amount of 1-30 wt. % by weight of the preservation solution, or 5-30, 10-30, 11-30, 12-30, 13-30, 14-30, 15-30, 15-29, 15-28, 15-27, 15-26, 15-25, 16-25, 17-25, 18-25, 19-25, 15-24, 15-23, 15-22, 16-24, 17-23 or 18-22 wt. % by weight of the preservation solution. The preservation solution may comprise one or more further ingredients. The further ingredients may be a flavouring, sweetener, organic acids, nutraceutical, colouring agent and/or thickening agent.

The thickening agent may include starch, modified starch, xanthan, galactomannans, such as guar gum and locust bean gum (LBG), gum Arabic, gum karaya, gum tragacanth and carboxymethyl cellulose (CMC).

The thickening agent may be present in an amount of no more than 10 wt. % by weight of the preservation solution or no more than 9, 8, 7, 6, 5, 4, 3, 2, 1, 0.9, 0.8, 0.7, 0.6, 0.5, 0.4, 0.3, 0.2, or no more than 0.1 wt. % by weight of the preservation solution.

In some embodiments, the thickening agent may be present in an amount of 0.01-5 wt. % by weight of the preservation solution, or 0.01-4, 0.02-3, 0.03-2, 0.04-2, 0.05-2, 0.05-1, 0.05-0.5, 0.05-0.4, 0.05-0.3, 0.05-0.3, 0.06-1.4, 0.07-0.3, 0.08-0.2, or 0.09-0.1 wt. % by weight of the preservation solution.

The flavouring may include chocolate powder (or cocoa) or a flavouring selected from chocolate (or cocoa), vanilla, strawberry, cinnamon, mint, hazelnut, caramel, biscuit, gingerbread, fruit flavouring, vegetable flavouring, spices, pumpkin spice, pistachio, eggnog, Irish Cream, alcoholic beverage flavouring, liqueurs, beer, rum, wine, gin cognac, plant and herb flavourings, agrimony, alfalfa, aloe vera, amaranth, angelica, anise, barberry, basil, bayberry, bee pollen, birch, bistort, blackberry, black cohosh, black walnut, blessed thistle, blue cohosh, blue vervain, boneset, borage, buchu, buckthorn, bugleweed, burdock, capsicum, cayenne, caraway, catnip, celery, centaury, chamomile, chaparral, chickweed, chinchona, cloves, coltsfoot, comfrey, cornsilk, couch grass, cramp bark, culver's root, cyani, cornflower, damiana, dandelion, devils claw, dong quai, echinacea, elecampane, ephedra, eucalyptus, evening primrose, eyebright, false unicorn, fennel, fenugreek, figwort, flaxseed, guarana, garlic, gentian, ginger, ginkgo, ginseng, golden seal, gotu kola, gum weed, hawthorn, hops, horehound, horseradish, horsetail, hoshouwu, hydrangea, hyssop, iceland moss, irish moss, jojoba, juniper, kelp, lady's slipper, lemon grass, licorice, lobelia, mandrake, marigold, marjoram, marshmallow, mistletoe, mullein, mustard, myrrh, nettle, oatstraw, Oregon grape, papaya, parsley, passion flower, peach, pennyroyal, peppermint, periwinkle, plantain, pleurisy root, pokeweed, prickly ash, psyllium, quassia, queen of the meadow, red clover, red raspberry, redmond clay, rhubarb, rose hips, rosemary, rue, safflower, saffron, sage, St. John's wort, sarsaparilla, sassafras, saw palmetto, scullcap, senega, senna, shepherd's purse, slippery elm, spearmint, spikenard, squawvine, stillingia, strawberry, taheebo, uva ursi, valerian, violet, watercress, white oak bark, white pine bark, wild cherry, wild lettuce, wild yam, willow, wintergreen, witch hazel, wood betony, wormwood, yarrow, yellow dock, yerba santa, yucca, lavender, thyme, or a combination of two or more thereof.

The flavouring may be present in an amount of no more than 10 wt. % by weight of the preservation solution or no more than 9, 8, 7, 6, 5, 4, 3, 2, 1, 0.9, 0.8, 0.7, 0.6, 0.5, 0.4, 0.3, 0.2, or no more than 0.1 wt. % by weight of the preservation solution.

In some embodiments, the flavouring may be present in an amount of 0.01-5 wt. % by weight of the preservation solution, or 0.01-4, 0.02-3, 0.03-1, 0.04-1, 0.05-1, 0.05-0.9, 0.05-0.8, 0.05-0.7, 0.05-0.6, 0.05-0.5, 0.06-0.4, 0.07-0.3, 0.08-0.2, or 0.09-0.2 wt. % by weight of the preservation solution.

The sweetener may be selected from a carbohydrate-based sweetener or a non-carbohydrate based sweetener. The carbohydrate-based sweetener may be a sugar substitutes like e.g. polyols such as sorbitol, mannitol, xylitol or combinations thereof, maltodextrins, dried glucose syrups, malt extracts, starches, trehalose, raftiline, raftilose, galactose, honey powders, and mixtures of same. The non-carbohydrate based sweetener may be an artificial sweetener like e.g. Splenda®, Acesulfame K®, or aspartame, and mixtures of the same. The non-carbohydrate based sweetener may be a natural sweetener, such as stevia.

The sweetener may be present in an amount of no more than 10 wt. % by weight of the preservation solution or no more than 9, 8, 7, 6, 5, 4, 3, 2, 1, 0.9, 0.8, 0.7, 0.6, 0.5, 0.4, 0.3, 0.2, or no more than 0.1 wt. % by weight of the preservation solution.

In some embodiments, the sweetener may be present in an amount of 0.1-10 wt. % by weight of the preservation solution, or 0.2-10, 0.3-10, 0.4-9, 0.5-8 0.6-7, 0.7-6, 0.8-5, 0.9-4, 1-3, or 1-2 wt. % by weight of the preservation solution.

The organic acid may be citric acid, lactic acid, acetic acid, tannic acid, malic acid, tartaric acid.

The organic acid may be present in an amount of no more than 10 wt. % by weight of the preservation solution or no more than 9, 8, 7, 6, 5, 4, 3, 2, 1, 0.9, 0.8, 0.7, 0.6, 0.5, 0.4, 0.3, 0.2, or no more than 0.1 wt. % by weight of the preservation solution.

In some embodiments, the organic acid may be present in an amount of 0.01-5 wt. % by weight of the preservation solution, or 0.01-4, 0.02-3, 0.03-2, 0.04-2, 0.05-2, 0.05-1, 0.05-0.5, 0.05-0.4, 0.05-0.3, 0.05-0.3, 0.06-1.4, 0.07-0.3, 0.08-0.2, or 0.1-0.2 wt. % by weight of the preservation solution.

The nutraceutical may be selected from the group consisting of ascorbic acid (vitamin C), B vitamins, biotin, fat soluble vitamins, folic acid, HCA (hydroxycitric acid), inositol, pyruvate, mineral ascorbates, mixed tocopherols, niacin (vitamin B3), orotic acid, PABA (para-aminobenzoic acid), pantothenates, pantothenic acid (vitamin B5), pyridoxine hydrochloride (vitamin B6), riboflavin (vitamin B2), synthetic vitamins, thiamine (vitamin B1), tocotrienols, vitamin A, vitamin D, vitamin E, vitamin F, vitamin K, vitamin oils, vitamin premixes, iron, vitamin-mineral premixes, water soluble vitamins, chromium, cobalt, copper, fluorine, iodine, magnesium, manganese, molybdenum, nickel, phosphorous, potassium, selenium, silicon, sodium, strontium, sulfur, vanadium, zinc, and combinations thereof.

The nutraceutical may be present in an amount of no more than 10 wt. % by weight of the preservation solution or no more than 9, 8, 7, 6, 5, 4, 3, 2, 1, 0.9, 0.8, 0.7, 0.6, 0.5, 0.4, 0.3, 0.2, or no more than 0.1 wt. % by weight of the preservation solution.

In some embodiments, the nutraceutical may be present in an amount of 0.01-5 wt. % by weight of the preservation solution, or 0.01-4, 0.02-3, 0.03-1, 0.04-1, 0.05-1, 0.05-0.9, 0.05-0.8, 0.05-0.7, 0.05-0.6, 0.05-0.5, 0.06-0.4, 0.07-0.3, 0.08-0.2, or 0.09-0.2 wt. % by weight of the preservation solution.

The colouring agent may be selected from the group consisting of edible glitter and/or any edible food colouring.

The colouring agent may be present in an amount of no more than 10 wt. % by weight of the preservation solution or no more than 9, 8, 7, 6, 5, 4, 3, 2, 1, 0.9, 0.8, 0.7, 0.6, 0.5, 0.4, 0.3, 0.2, or no more than 0.1 wt. % by weight of the preservation solution. In some embodiments, the colouring agent may be present in an amount of 0.01-5 wt. % by weight of the preservation solution, or 0.01-4, 0.02-3, 0.03-1, 0.04-1, 0.05-1, 0.05-0.9, 0.05-0.8, 0.05-0.7, 0.05-0.6, 0.05-0.5, 0.06-0.4, 0.07-0.3, 0.08-0.2, or 0.09-0.2 wt. % by weight of the preservation solution.

The preservation solution may comprise water in an amount of at least 5 wt. % by weight of the preservation solution, or at least 10, 15, 20, 25, 30, 35, 40, 45, or at least 50 wt. % by weight of the preservation solution. In some embodiments, the preservation solution may comprise water in an amount of no more than 80 wt. % by weight of the preservation solution or no more than 75, 70, 65, 60, 55, or no more than 50 wt. % by weight of the preservation solution.

In some embodiments, the preservation solution may comprise water in an amount of 30-80 wt. % by weight of the preservation solution, or 35-75, 40-65, 45-65, or 45-60 wt. % by weight of the preservation solution.

Preferably, the preservation solution comprises the same ingredients as the first solution of the second aspect of the present invention. In such an embodiment, the preservation solution does not comprise a metal salt.

In a fourth aspect of the present invention, there is provided a method of preparing a product according to the third aspect of the invention comprising the steps of:
a) providing an edible bead according to the first aspect of the invention; and
b) adding the edible bead to an aqueous solution, liquid product and/or food product.

The aqueous solution, liquid product and/or food product may be the same aqueous solution, liquid product and/or food product as described in the third aspect of the invention.

According to a fifth aspect of the invention, there is provided a container comprising the product of the third aspect of the invention.

According to a sixth aspect of the invention there is provided a method of preparing a container of a fifth aspect of the invention comprising steps of:
a) providing a product according to the third aspect of the present invention; and
b) adding the product to a container according to the sixth aspect of the present invention.

The further aspects of the present invention may incorporate any of the features of the other aspects of the invention described herein as desired or as appropriate.

### DETAILED DESCRIPTION OF THE INVENTION

In order that the invention may be more clearly understood one or more embodiments thereof will now be described, by way of example only, with reference to the accompanying drawings, of which:

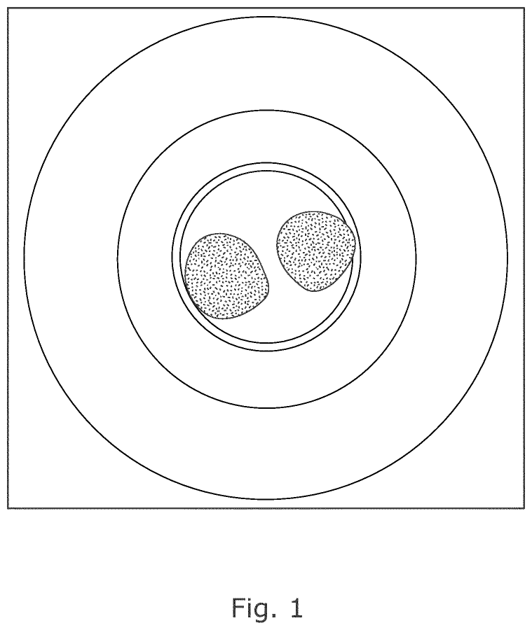

FIG. 1 shows an image of an edible bead according to the present invention.

### EXAMPLES

Edible beads of Examples 1-12 were prepared according to the second aspect of the present invention as set out below.

1.65 ml of a first solution was added to a second solution to form an edible bead. The ingredients for the first solution of Examples 1-12 are shown in tables 1-2 below. The second solution of Examples 1-12 comprised deionised water 99.5 wt. % and sodium alginate 0.5 wt. % by weight of the second solution. The resulting mixture was then gently stirred to fully submerge the edible bead in the mixture and left for 2-3 minutes.

The edible bead was then removed from the solution and rinsed with deionised water.

The resulting edible bead comprised a liquid filling having the same composition and weight amounts as the corresponding first solution detailed in tables 1-2 below.

The process was repeated to form a plurality of edible beads.

The edible beads had an average weight of 0.7 g and a diameter of 8-10 mm.

Surprisingly, the inventors found that the edible beads tasted similar to corresponding “full sugar” edible beads whilst having a reduced amount of sugars and calories. Moreover, the inventors surprisingly observed that the filling of the bead did not solidify in storage.

TABLE 1

| | Exam- | Exam- | Exam- | Exam- | Exam- | Exam- |
|---|---|---|---|---|---|---|
| | ple | ple | ple | ple | ple | ple |
| | 1 | 2 | 3 | 4 | 5 | 6 |
| Ingredient | Wt. % by weight of the first solution | | | | | |
| Deionised Water | 52.6 | 52.6 | 52.6 | 52.6 | 52.6 | 52.6 |
| Inulin | 20 | 15 | 12.5 | 20 | 15 | 12.5 |
| Fructo | 5 | 10 | 12.5 | 5 | 10 | 12.5 |
| Oligosaccharides | | | | | | |
| Galacto | 0 | 0 | 0 | 0 | 0 | 0 |
| Oligosaccharides | | | | | | |
| Flavouring agent | 2 | 2 | 2 | 2 | 2 | 2 |
| Sucrose | 8 | 8 | 8 | 0 | 0 | 0 |
| Fructose | 0 | 0 | 0 | 4 | 4 | 4 |
| Glucose | 0 | 0 | 0 | 4 | 4 | 4 |
| Calcium Lactate | 2 | 2 | 2 | 2 | 2 | 2 |
| Tea extract | 10 | 10 | 10 | 10 | 10 | 10 |
| Citric Acid | 0.3 | 0.3 | 0.3 | 0.3 | 0.3 | 0.3 |
| Xanthan Gum | 0.1 | 0.1 | 0.1 | 0.1 | 0.1 | 0.1 |

TABLE 2

| | Exam- | Exam- | Exam- | Exam- | Exam- | Exam- |
|---|---|---|---|---|---|---|
| | ple | ple | ple | ple | ple | ple |
| | 7 | 8 | 9 | 10 | 11 | 12 |
| Ingredient | Wt. % by weight of the first solution | | | | | |
| Deionised Water | 52.6 | 52.6 | 52.6 | 52.6 | 52.6 | 52.6 |
| Inulin | 20 | 15 | 12.5 | 20 | 15 | 12.5 |
| Fructo | 0 | 0 | 0 | 0 | 0 | 0 |
| Oligosaccharides | | | | | | |
| Galacto | 5 | 10 | 12.5 | 5 | 10 | 12.5 |
| Oligosaccharides | | | | | | |
| Flavouring agent | 2 | 2 | 2 | 2 | 2 | 2 |
| Sucrose | 8 | 8 | 8 | 0 | 0 | 0 |
| Fructose | 0 | 0 | 0 | 4 | 4 | 4 |
| Glucose | 0 | 0 | 0 | 4 | 4 | 4 |
| Calcium Lactate | 2 | 2 | 2 | 2 | 2 | 2 |
| Tea extract | 10 | 10 | 10 | 10 | 10 | 10 |
| Citric Acid | 0.3 | 0.3 | 0.3 | 0.3 | 0.3 | 0.3 |
| Xanthan Gum | 0.1 | 0.1 | 0.1 | 0.1 | 0.1 | 0.1 |

The one or more embodiments are described above by way of example only. Many variations are possible.

1: An edible bead comprising an outer polysaccharide gel membrane and a filling, wherein the filling comprises a tea extract and at least one soluble dietary fibre and wherein the filling comprises less than 15 wt. % sugars by weight of the filling.

2: An edible bead according to claim 1, wherein the tea extract in the form of a liquid tea extract, infusion, an instant soluble tea extract, spray dried tea extract, freeze dried tea extract, and/or a blend of freeze dried soluble tea extract, preferably a liquid tea extract.

3: An edible bead according claim 1, wherein the tea extract is selected from the group consisting of black tea, white tea, fruit tea, green tea, rooibos tea, oolong tea, chamomile tea, peppermint tea, ginger tea, cinnamon tea, lemongrass tea, rosemary tea, pu-erh tea, olive leaf tea, barley tea, liquorice tea, eucalyptus tea, gingko tea, sage tea, raspberry tea, valerian root tea, elderberry flower tea, lavender tea, turmeric tea, purple tea, pine needle tea, echinacea tea, honeybush tea, rose tea, jasmine tea, cranberry tea, dandelion tea, guava tea, thyme tea, matcha tea, chai tea, lemon balm tea.

4: An edible bead according to claim 1, wherein the at least one soluble fibre is selected from group consisting of inulin, fructooligosaccharide (FOS), levan, polydextrose, kestose, nystose, raffinose, galacto-oligosaccharides, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, milk oligosaccharides, 2′-fucosyl lactose, lacto-n-neotetraose, glucan (i.e., glucose containing) oligosaccharides, cello-oligosaccharides (or cellodextrins), resistant dextrins (e.g., soluble corn fiber, soluble wheat fiber, soluble tapioca fiber, soluble pea fibre), nigero-oligosaccharides, nigerotriose, nigerotetraose, kojitriose, kojitetraose, dextrans, beta glucans, lichenan, isolichenan, and combinations thereof.

5: An edible bead according to claim 4, wherein the at least one soluble dietary fibre is selected from the group consisting of inulin, galacto-oligosaccharide, polydextrose, fructooligosaccharide (FOS) and combinations thereof.

6: An edible bead according to claim 1, wherein the at least one soluble dietary fibre is present in an amount of at least 5 wt. % by weight of the filling, preferably in an amount of from 5-40 wt. % by weight of the filling.

7: An edible bead according to claim 1, wherein the sugars are selected from the group consisting of glucose, sucrose, fructose, galactose, lactose, maltose, isomaltose, sugar hydrates (such as dextrose monohydrate, for example), and combinations thereof.

8: An edible bead according to claim 1, wherein the filling comprises a tea extract in an amount of at least 1 wt. % by weight of the filling, preferably from 5-20 wt. % by weight of the filling.

9: An edible bead according to claim 1, wherein the filling is liquid.

10: An edible bead according to claim 1, wherein the polysaccharide is a hydrocolloid.

11: An edible bead according to claim 1, wherein the polysaccharide is selected from the group consisting of alginate, low methoxy pectin, guar gum and combinations thereof, preferably wherein the polysaccharide is an alkaline earth metal alginate, preferably calcium alginate.

12: An edible bead according to claim 1, wherein the filling does not comprise a hydrocolloid.

13: An edible bead according to claim 1, wherein the filling further comprises a flavouring, sweetener, organic acids, nutraceutical, colouring agent and/or thickening agent.

14: A process for preparing an edible bead, the process comprising the steps of:
a) preparing a first solution comprising a metal salt, a tea extract and at least one soluble dietary fibre;
b) preparing a second solution comprising at least one polysaccharide; and
c) contacting the first solution with the second solution to form a polysaccharide gel membrane and encapsulating the first solution in the polysaccharide gel membrane.

15: A process according to claim 14, wherein the at least one soluble dietary fibre is selected from the group consisting of inulin, fructooligosaccharide (FOS), galacto-oligosaccharide, polydextrose and combinations thereof.

16: A process according to claim 14, wherein the metal salt is a calcium metal salt, preferably selected from the group consisting of calcium lactate, calcium chloride, calcium lactate gluconate and combinations thereof.

17: A process according to claim 14, wherein the polysaccharide is a hydrocolloid, preferably a low methoxy pectin, guar gum and combinations thereof, more preferably sodium alginate.

18: A process according to claim 14, wherein the first solution does not comprise a hydrocolloid.

19: A process according to claim 14, wherein the tea extract is in the form of a liquid tea extract, infusion, an instant soluble tea extract, spray dried tea extract, freeze dried tea extract, and/or a blend of freeze dried soluble tea extract, preferably a liquid tea extract, preferably a liquid tea extract.

20: A process according to claim 14, wherein the first solution comprises less than 15 wt. % sugar by weight of the first solution.

21: A product comprising one or more edible beads according to claim 1.

22: A product according to claim 21, wherein the product comprises a beverage liquid, preferably wherein the edible beads are dispersed in the beverage liquid, preferably wherein the beverage liquid is a coffee, tea, infusion of one or more plants, herbs, fruits or spices, chocolate, carbonated liquid, flavoured water, alcoholic liquid and/or juice.

23: A product according to claim 21, wherein the product comprises one or more edible beads dispersed in an aqueous solution, preferably wherein the aqueous solution is a preservation solution comprising at least one soluble dietary fibre, a liquid tea extract, a sweetener, organic acid, thickening agent nutraceutical, colouring agent and/or a sugar.

24: A product according to claim 23, wherein the preservation solution does not comprise a metal salt.

25: A product according to claim 21, wherein the product comprises a food product, preferably wherein the edible beads are disposed on the food product, preferably wherein the food product is a dairy product, confectionery product, savoury product, wholegrain product, frozen product, and/or baked product.

26: A method of preparing a product according to claim 21 comprising the steps of:
a) providing the edible bead; and
b) adding the edible bead to an aqueous solution, liquid product and/or food product.

27: A container comprising a product according to claim 21.

28: A method of preparing a container according to claim 26 comprising the steps of:
a) providing the product; and
b) adding the product to the container.
